(19) United States
(12) Patent Application Publication
(10) Pub. No.: US 2025/0320388 A1
(43) Pub. Date: Oct. 16, 2025

(54) WATERBORNE ADHESIVE AND/OR SEALANT COMPOSITION

(71) Applicant: SOUDAL, Turnhout (BE)

(72) Inventors: Guy DE HOUWER, Turnhout (BE); Bart FORIER, Turnhout (BE)

(21) Appl. No.: 18/712,328

(22) PCT Filed: Nov. 25, 2022
(86) PCT No.: PCT/EP2022/083309

§ 371 Date: May 22, 2024

(30) Foreign Application Priority Data
Nov. 26, 2021 (EP) 21210878.1

(51) Int. Cl. C09J 133/14; C09D 7/45; C09D 7/61; C09D 7/65; C09D 133/04; C09D 133/14; C09J 5/00; C09J 11/04; C09J 11/08; C09J 133/04

(52) U.S. Cl. CPC C09J 133/14; C09D 7/45; C09D 7/61; C09D 7/65; C09D 133/04; C09D 133/14; C09J 5/00; C09J 11/04; C09J 11/08; C09J 133/04

(57) ABSTRACT

The present invention relates to waterborne adhesive and/or sealant compositions having a high solids content, said waterborne adhesive and/or sealant compositions thereby comprising an aqueous composition [composition (C), herein after], said composition (C) comprising, relative to the total weight of the composition (C): from 5.00 to 80.00 percent by weight [wt. %, herein after] of at least one aqueous dispersion comprising at least one polymer [polymer (A), herein after] selected from the group consisting of acrylic polymer, polyurethane, polyvinyl ester, polysiloxane, copolymers, and a mixture of two or more thereof; from 1.00 to 50.00 wt. % of at least one redispersible polymer powder; and from 5.00 to 70.00 wt. % of at least one filler. The present invention further relates to a method for the manufacturing of the composition (C), to a cured composition (C) obtainable from the composition (C), to a method of bonding two substrates or at least part of two substrates by using the composition (C), and to a method of sealing or coating by using the composition (C).

### FIELD OF INVENTION

The present invention relates to waterborne adhesive and/or sealant compositions having a high solids content. The present invention further relates to a method of manufacturing said waterborne adhesive and/or sealant composition having a high solids content and the use thereof in the bonding, sealing or coating of materials.

### BACKGROUND OF THE INVENTION

Adhesive and/or sealant compositions have numerous applications, for example in the construction field, namely in window and door profiles, pipes and guttering, flooring, glazing, insulation, building panels, and roofing.

There is a growing demand for high performance and environment-friendly construction products which shows a responsible attitude towards the environment and resources. The result of this is a long life of the sealant as well as the building. For this reason different certification systems such as notably Emicode classes EC1 and EC1+, Blue Angel RAL UZ 113, DIN EN 15651 and DIN EN ISO 11600 were introduced. These certification systems place requirements on the buildings as well as on the used products.

In particular, volatile organic compounds (VOC) are limited by the certification systems such as notably Emicode classes EC1 and EC1+ and Blue Angel RAL UZ 113. In order to achieve a healthy living environment and ‘clean’ air, it is essential to pay attention to materials used for building products, including sealants.

With regard to eco-friendliness, the waterborne sealants are clearly ahead of conventional reactive sealants (polysiloxane or silicone technology, hybrid silane modified technology SMP, polyurethane technology). Most of the reactive sealants release methanol or other harmful chemicals such as acetic acid as a reaction product of the chemical curing process. This has definitely an impact on the total emission of VOC content. The waterborne sealants do not emit as many volatile organic compounds (VOC) that are hazardous to health and the environment.

Joint sealants are known to be most appropriate for sealing connection and/or expansion joints in building and construction applications. In order to withstand all these possible effects, both inside and outside, the sealants used should be permanently elastic and durable. The durability of a joint sealant depends crucially on the quality of a sealant and its material and mechanical properties.

The standard DIN EN ISO 11600 classifies joint sealants in different classes depending on the respective requirements, for instance in terms of modulus and elastic recovery. In general, the term “elastic recovery” refers to the degree to which a sealant, after being cured, recovers to its original dimension after being extended at a certain degree for a specific time period.

One of the drawbacks of most of the waterborne sealants is that they have more of a plasto-elastic or an elasto-plastic behavior, rather than this desired and targeted elastic behavior.

Furthermore, waterborne sealants are known to adhere less to glass, plastics and ceramic substrates. It is therefore known that the presence of higher amounts of a binder (i.e. waterborne polymer dispersions) can enhance said adhesion to various substrates. However, this also means that at the same time more water is added, which in turn affects volume shrinkage of the sealant, after being cured, in a negative way. It goes without saying that the transport of too much water should be avoided.

Accordingly, there is a further need to provide improved environment-friendly waterborne sealants and/or waterborne adhesives having a high solids content level and which are economical to transport, and which lead to cured sealants and/or adhesives being characterized by a reduction of shrinkage, while maintaining or improving other mechanical properties such as elastic recovery, elongation at break, high or low modulus, and adhesion.

### SUMMARY OF THE INVENTION

The Applicant has now found waterborne sealant and/or adhesive compositions which fulfil the above mentioned needs in a surprisingly effective manner.

Thus, the object of the present invention is to provide an aqueous composition [composition (C), herein after] suitable for use as a waterborne sealant and/or a waterborne adhesive comprising, relative to the total weight of the composition (C):
from 5.00 to 80.00 percent by weight [wt. %, herein after] of at least one aqueous dispersion comprising at least one polymer [polymer (A), herein after] selected from the group consisting of acrylic polymer, polyurethane, polyvinyl ester, polysiloxane, copolymers, and a mixture of two or more thereof;
from 1.00 to 50.00 wt. % of at least one redispersible polymer powder; and
from 5.00 to 70.00 wt. % of at least one filler.

In another aspect, the present invention further provides a method for the manufacturing of the composition (C), as detailed above.

It is a further object of the present invention to provide a waterborne sealant and/or waterborne adhesive comprising the composition (C) having a high solids content.

It is also a further object of the present invention to provide a cured composition (C), obtainable from the composition (C) having a high solids content.

It is also a further object of the present invention to provide a method of bonding two substrates or at least part of two substrates by using the composition (C) having a high solids content.

It is also a further object of the present invention to provide a method of sealing or coating at least part of a substrate and/or between at least part of two substrates by using the composition (C) having a high solids content.

### DETAILED DESCRIPTION OF THE INVENTION

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

As used herein, the terms “optional” or “optionally” means that a subsequently described event or circumstance can or cannot occur, and that the description includes instances where said event or circumstance occurs and instances where it does not.

Within the context of the present invention, the expression “at least one aqueous dispersion” is intended to denote one or more than one aqueous dispersion. Mixtures of aqueous dispersions can also be used for the purpose of the invention.

Within the context of the present invention, the expression “at least one polymer (A)” is intended to denote one or more than one polymer (A). Mixtures of polymers (A) can also be used for the purpose of the invention.

Within the context of the present invention, the expression “at least one redispersible polymer powder” is intended to denote one or more than one redispersible polymer powder. Mixtures of redispersible polymer powders can also be used for the purpose of the invention.

Within the context of the present invention, the expression “at least one filler” is intended to denote one or more than one filler. Mixtures of fillers can also be used for the purpose of the invention.

In the remainder of the text, the expressions “aqueous dispersion”, “polymer (A)”, “redispersible polymer powder”, and “filler” are understood, for the purposes of the present invention, both in the plural and the singular form.

As used in the foregoing and hereinafter, the following definitions apply unless otherwise noted.

The term alkyl, alone or in combination, means an alkane-derived radical containing from 1 to 18, preferably 1 to 12 carbon atoms, unless otherwise specified, for example C_{F-G} alkyl defines a straight or branched alkyl radical having from F to G carbon atoms, e.g. C₁₋₄ alkyl defines a straight or branched alkyl radical having from 1 to 4 carbon atoms such as for example methyl, ethyl, 1-propyl, 2-propyl, 1-butyl, 2-butyl, 2-methyl-1-propyl. An alkyl group may be a straight chain alkyl or branched alkyl. Preferably, straight or branched alkyl groups containing from 1 to 12, more preferably 1 to 8, even more preferably 1 to 6, and most preferably 1 to 4 carbon atoms, such as methyl, ethyl, propyl, isopropyl, butyl, tert-butyl and the like. Alkyl also includes a straight chain or branched alkyl group that contains or is interrupted by a cycloalkyl portion. The straight chain or branched alkyl group is attached at any available point to produce a stable compound. Examples of this include, but are not limited to, 4-(isopropyl)-cyclohexylethyl or 2-methyl-cyclopropylpentyl.

The term alkenyl, alone or in combination, means a straight or branched hydrocarbon containing 2 to 18, preferably 2 to 12, more preferably 2 to 10, even more preferably 2 to 8, most preferably 2 to 4 carbon atoms, unless otherwise specified, and at least one, preferably 1 to 3, more preferably 1 to 2, most preferably one, carbon to carbon double bond. Examples of alkenyl groups include ethenyl, propenyl, isopropenyl, butenyl, cyclohexenyl, cyclohexenylalkyl and the like. Alkenyl also includes a straight chain or branched alkenyl group that contains or is interrupted by a cycloalkyl portion. Carbon to carbon double bonds may be either contained within a cycloalkyl portion, with the exception of cyclopropyl, or within a straight chain or branched portion.

The term aryl, alone or in combination, means phenyl, naphthyl or anthracenyl optionally carbocyclic fused with a cycloalkyl or heterocyclyl of preferably 5 to 7, more preferably 5 to 6, ring members and/or optionally substituted with 1 to 5 groups or substituents. An aryl may be optionally substituted whereby the substituent is attached at one point to the aryl or whereby the substituent is attached at two points to the aryl to form a bicyclic system e.g. benzodioxole, benzodioxan, benzimidazole.

The term heterocyclyl, alone or in combination, is intended to denote a saturated, partially unsaturated or completely unsaturated monocycle, bicycle, or tricycle having 3 to 12 carbon atoms and containing 1, 2, 3, or 4 heteroatoms each independently selected from O, S, P or N, and are optionally benzo fused or fused heteroaryl of 5-6 ring members and/or are optionally substituted as in the case of cycloalkyl. Heterocycyl is also intended to include oxidized S or N, such as sulfinyl, sulfonyl and N-oxide of a tertiary ring nitrogen. The point of attachment is at a carbon or nitrogen atom. In each case the heterocyclyl may be condensed with an aryl to form a bicyclic ring system.

The term cycloalkyl refers to a cyclic or polycyclic alkyl group containing 3 to 15 carbon atoms. Preferably, cycloalkyl groups are monocyclic, bicyclic or tricyclic ring systems of 3 to 8, more preferably 3 to 6, ring members per ring, such as cyclopropyl, cyclopentyl, cyclohexyl, adamantyl and the like.

The term aralkyl refers to organic compounds containing an aromatic nucleus to which an alkyl radical is bonded. These alkyl radicals include methyl, ethyl, propyl, butyl, octyl, etc. radicals. The term aralkyl is thus seen to include aralkyl hydrocarbons such as the alkyl benzenes, and the various alkyl naphthalenes. From this definition of the term aralkyl compound it is seen that the term includes compounds such as benzyl, the three isomeric xylyls, the two isomeric trimethyl benzenes, ethyl benzene, p-methyl biphenyl, 1-methyl naphthalene, etc.

The term “saturated”, as used herein, means that a moiety has no double or triple bonds.

The term “unsaturated”, as used herein, means that a moiety has one or more double or triple bonds.

### Polymer (A)

As said, polymer (A) as comprised within the at least one aqueous dispersion as used in the composition (C) of the present invention is selected from the group consisting of acrylic polymer, polyurethane, polyvinyl ester, polysiloxane, copolymers, and a mixture of two or more thereof.

Each of the polymers (A) as comprised within the at least one aqueous dispersion as used in the composition (C) of the present invention, as detailed above, can also comprise silane-modified polymers (A). For example, in case the polymer (A) is equal to an acryclic polymer, said acrylic polymer can also comprise a silane-modified acrylic polymer, as detailed below.

Within the context of the present invention, the term “silane-modified” identifies compounds which have silane groups. “Silane-modified polymers”, accordingly, are polymers, more particularly organic polymers, which have at least one, preferably two or more, silane groups. Silane is a molecule of one central silicon atom with four attachments. The attachments can be any combination of organic or inorganic groups such as hydrogen, or chorine. The silane groups may take the form of side groups, or (main chain) end groups.

Suitable commercially available silane-modified polymers (A) for use in the composition (C) of the present invention notably include Acronal® DS5036 X SIL, Acronal® S 813 available from BASF AG, Germany; Texicryl® 13-065 available from Scott Bader; Revacryl 385 available from Synthomer.

The polymers used as the polymer (A), as detailed above, are generally products obtained by the polymerization of at least one type of monomer. Where the polymers contain two or more types of monomer, these monomers may be arranged in the polymer in any form, meaning that they may be present either randomly distributed or in blocks.

According to one embodiment of the composition (C) of the present invention, the polymer (A) as comprised within the at least one aqueous dispersion is an acrylic polymer, whereby the acrylic polymer comprises recurring units derived from at least one (meth)acrylic acid monomer or/and at least one (meth)acrylic acid ester monomer.

The term “at least one (meth)acrylic acid monomer”, as used herein, is understood to mean that the acrylic polymer may comprise recurring units derived from one or more than one (meth)acrylic acid monomer, as described above. In the rest of the text, the expression “(meth)acrylic acid monomer” is understood, for the purposes of the present invention, both in the plural and the singular, that is to say that it denotes one or more than one (meth)acrylic acid monomer.

The term “at least one (meth)acrylic acid ester monomer”, as used herein, is understood to mean that the polymer (A) may comprise recurring units derived from one or more than one (meth)acrylic acid ester monomer, as described above. In the rest of the text, the expression “(meth)acrylic acid ester monomer” is understood, for the purposes of the present invention, both in the plural and the singular, that is to say that it denotes one or more than one (meth)acrylic acid ester monomer.

Preferably, the (meth)acrylic acid monomer is according to general formula (I):

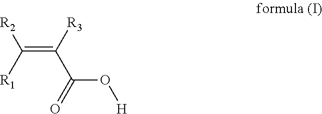

wherein:
each of R₁ and R₂, equal to or different from each other and at each occurrence, is independently selected from the group consisting of hydrogen, C₁₋₄ alkyl, C₂₋₄ alkenyl, and C(O)OR₁₂, and wherein each of R₁₂ is independently selected from hydrogen or C₁₋₄ alkyl.
each of R₃ is independently selected from the group consisting of hydrogen, C₁₋₄ alkyl, C₂₋₄ alkenyl, CN, and C(O)OR₃₁, and wherein R₃₁ is independently selected from hydrogen or C₁₋₄ alkyl.

Preferably, the (meth)acrylic acid ester monomer is according to general formula (II):

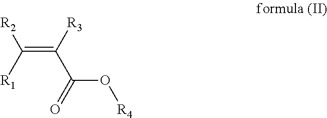

wherein R₁, R₂, and R₃ have each the same meaning as defined above for formula (I), and wherein:
each of R₄ is independently selected from the group consisting of C₁₋₁₈ alkyl, C₂₋₁₈ alkenyl, CF₃, C₃₋₁₀ cycloalkyl, aryl, and aralkyl, and wherein said C₁₋₁₈ alkyl, C₂₋₁₈ alkenyl, C₃₋₁₀ cycloalkyl, aryl, and aralkyl are optionally substituted with (CX₂)ₙ₋₁CX₃, O(R₄₁O)ₘR₄₂, heterocyclyl, NR₄₁, wherein X is H or F, wherein n is an integer in the range from 1 to 16, and wherein each of R₄₁ and R₄₂, equal to or different from each other and at each occurrence, is independently selected from hydrogen, C₁₋₄ alkyl, or phenyl, and wherein m is an integer in the range from 0 to 2.

Preferably, each of R₁ in the (meth)acrylic acid monomer according to general formula (I) or the (meth)acrylic acid ester monomer according to general formula (II) is independently selected from the group consisting of hydrogen, methyl, ethyl, n-propyl, isopropyl, n-butyl, isobutyl, tert-butyl, and C(O)OR₁₂, and wherein each of R₁₂, is independently selected from the group consisting of hydrogen, methyl, ethyl, n-propyl, isopropyl, n-butyl, isobutyl, and tert-butyl. More preferably, each of R₁ is independently selected from the group consisting of hydrogen, methyl, and C(O)OR₁₂, and wherein each of R₁₂ is independently selected from hydrogen or methyl.

Preferably, each of R₂ in the (meth)acrylic acid monomer according to general formula (I) or the (meth)acrylic acid ester monomer according to general formula (II) is independently selected from the group consisting of hydrogen, methyl, ethyl, n-propyl, isopropyl, n-butyl, isobutyl, tert-butyl, and C(O)OR₁₂, and wherein each of R₁₂ is independently selected from the group consisting of hydrogen, methyl, ethyl, n-propyl, isopropyl, n-butyl, isobutyl, and tert-butyl. More preferably, each of R₂ is independently selected from the group consisting of hydrogen, methyl, and C(O)OR₁₂, and wherein each of R₁₂ is independently selected from hydrogen or methyl. Even more preferably, R₂ is hydrogen.

Preferably, each of R₃ in the (meth)acrylic acid monomer according to general formula (I) or the (meth)acrylic acid ester monomer according to general formula (II) is independently selected from the group consisting of hydrogen, methyl, ethyl, n-propyl, isopropyl, n-butyl, isobutyl, tert-butyl, CN, and C(O)OR₃₁, and wherein R₃₁ is independently selected from the group consisting of hydrogen, methyl, ethyl, n-propyl, isopropyl, n-butyl, isobutyl, and tert-butyl. More preferably, each of R₃ is independently selected from the group consisting of hydrogen, methyl, CN, and C(O)OR₃₁, and wherein R₃₁ is independently selected from hydrogen or methyl.

Preferably, each of R₄ in the (meth)acrylic acid ester monomer according to general formula (II) is independently selected from the group consisting of C₁₋₁₈ alkyl, CF₃, C₆₋₁₀ cycloalkyl, phenyl, and benzyl, and wherein said C₁₋₁₈ hydrocarbon, C₆₋₁₀ cycloalkyl, phenyl, and benzyl are optionally substituted with (CX₂)ₙ₋₁CX₃, O(R₄₁O)ₘR₄₂, oxiranyl, and NR₄₁, wherein X is H or F, wherein n is an integer in the range from 1 to 16, and wherein each of R₄₁ and R₄₂, equal to or different from each other and at each occurrence, is independently selected from hydrogen, methyl, or phenyl, and wherein m is an integer in the range from 0 to 1.

Preferred (meth)acrylic acid monomers according to general formula (I) are acrylic acid, methacrylic acid, and ethylene oxide adducts of (meth)acrylic acid.

Preferred (meth)acrylic acid ester monomers according to general formula (II) are ethyl diglycol acrylate, 4-tert-butylcyclohexyl acrylate, dihydrocyclopentadienyl acrylate, phenoxyethyl (meth)acrylate, isobornyl(meth)acrylate, dimethylaminoethyl(meth)acrylate, cyanoacrylates, citraconates, itaconates, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-pentyl(meth)acrylate, n-hexyl(meth)acrylate, cyclohexyl-(meth)acrylate, n-heptyl(meth)acrylate, n-octyl(meth)acrylate, 2-propylheptyl-(meth)acrylate, 2-ethylhexyl(meth)acrylate, nonyl(meth)acrylate, decyl-(meth)acrylate, isodecyl(meth)acrylate, dodecyl(meth)acrylate, phenyl-(meth)acrylate, tolyl(meth)acrylate, benzyl(meth)acrylate, 2-methoxyethyl-(meth)acrylate, 3-methoxybutyl(meth)acrylate, 2-hydroxyethyl(meth)acrylate, 2-hydroxypropyl(meth)acrylate, stearyl(meth)acrylate, glycidyl(meth)acrylate, 2-aminoethyl(meth)acrylates, trifluoromethylmethyl(meth)acrylate, 2-trifluoromethylethyl(meth)acrylate, 2-perfluoroethylethyl(meth)acrylate, 2-perfluoroethyl-2-perfluorobutyl-ethyl-meth)acrylate, 2-perfluoroethyl(meth)acrylate, perfluoromethyl(meth)acrylate, diperfluoro-methylmethyl(meth)acrylate, 2-perfluoromethyl-2-perfluoroethylmethyl(meth)acrylate, 2-perfluorohexylethyl(meth)acrylate, 2-perfluorodecylethyl(meth)acrylate and 2-perfluorohexadecylethyl(meth)acrylate.

According to one embodiment of the composition (C) of the present invention, the acrylic polymer as comprised within the at least one aqueous dispersion is a homopolymer consisting essentially of recurring units derived from one (meth)acrylic acid monomer, as detailed above, or one (meth)acrylic acid ester monomer, as detailed above. It is further understood that the polymer (A) being a homopolymer may still comprise other moieties such as defects, end-groups, which do not affect nor impair its physico-chemical properties.

According to another embodiment of the composition (C) of the present invention, the acrylic polymer as comprised within the at least one aqueous dispersion is a copolymer comprising at least one (meth)acrylic acid monomer, as detailed above, and at least one (meth)acrylic acid ester monomer, as detailed above, or at least two (meth)acrylic acid monomers or at least two (meth)acrylic acid ester monomers. The proportion and ratio of each of these monomers being selected in such a manner that the resultant copolymers have the desired performance properties for waterborne sealants and adhesives.

Preference is given more particularly to copolymers of n-butyl acrylate and methyl methacrylate, which are used in a molar ratio at which the resultant copolymer possesses a glass transition temperature which lies between those of the corresponding homopolymers.

Suitable preparation methods of the acrylic polymer as comprised within the at least one aqueous dispersion as used in the composition (C) of the present invention, are generally well-known in the art and can be carried out radically including for example free radical polymerization and controlled radical polymerization, said controlled radical polymerization thereby further including chain transfer polymerization and living radical polymerization such as atom transfer radical polymerization; or ionically; or by metal catalysis.

According to certain embodiments of the composition (C) of the present invention, the acryclic polymer as comprised within the at least one aqueous dispersion, as detailed above, further comprises recurring units derived from other ethylenically unsaturated monomers.

Non-limiting examples of ethylenically unsaturated monomers mention maybe made of alkenes, such as ethylene, propylene, butylene, conjugated dienes, such as butadiene and isoprene and copolymers of butadiene and isoprene; aromatic vinyl monomers, such as styrene, vinyltoluene, α-methylstyrene, chlorostyrene, styrenesulfonic acid and its salts thereof; vinyl and halovinylidene monomers such as vinyl chloride, vinylidene chloride, vinyl fluoride and vinylidene fluoride; vinyl esters, such as vinyl formate, vinyl acetate, vinyl propionate, vinyl butyrate, vinyl isobutyrate, vinyl valerate, vinyl caproate, vinyl pivalate, vinyl benzoate, and vinyl cinnamate; allyl esters, such as allyl acetate, allyl propionate, and allyl lactate; vinyl ethers, such as methyl vinyl ether, ethyl vinyl ether and n-butyl vinyl ether; vinyl ketones, such as methyl vinyl ketones, ethyl vinyl ketones and isobutyl vinyl ketones; maleic anhydride, maleic acid, and monoalkyl esters and dialkyl esters of maleic acid such as dimethyl maleate, diethyl maleate, dibutyl maleate, dioctyl maleate, diisooctyl maleate, dinonyl maleate, diisodecyl maleate, and ditridecyl maleate; fumaric acid and monoalkyl and dialkyl esters of fumaric acid such as dimethyl fumarate, diethyl fumarate, dipropyl fumarate, dibutyl fumarate, dioctyl fumarate, diisooctyl fumarate, and didecyl fumarate; maleimide monomers, such as maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide; acrylonitrile monomers, such as acrylonitrile and methacrylonitrile; amido-containing vinyl monomers, such as acrylamide and methacrylamide; and the like.

According to another embodiment of the composition (C) of the present invention, the acrylic polymer as comprised within the at least one aqueous dispersion, as detailed above, is a silane-modified acrylic polymer thereby further comprising recurring units derived from at least one monomer having at least one silane group according to general formula (III) [monomer (Si), herein after]:

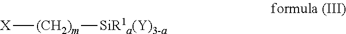

wherein:
   X is each independently a group of formula (IV):

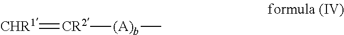

wherein:
   each of A is independently selected from the group consisting of —O—, —S—, —(R²)N—, —O—CO—, —O—CO—N(R²)—, —N(R²)—CO—O—, —N(R²)—CO—NH—, —NH—CO—N(R²)—, and —N(R²)—CO—N(R²)—, preferably A is each independently selected from the group consisting of —O—, —O—CO—, —O—CO—N(R²)—, and —N(R²)—CO—O—; wherein each of R^{1′}, R^{2′}, and R², equal to or different from each other and at each occurrence, is independently selected from the group consisting of hydrogen, C₁₋₆ alkyl, and C₂₋₆ alkenyl;
each of R¹ is independently selected from the group consisting of C₁₋₁₀ alkyl, C₂₋₁₀ alkenyl, C₃₋₁₀ cycloalkyl, and C₆₋₁₀ aryl group;
each of Y is independently selected from a hydroxyl or hydrolysable group;
each of a is an integer ranging from 0 to 3;
each of b is an integer ranging from 0 to 1;
each of m is an integer ranging from 0 to 10.

Suitable preparation methods of the silane-modified acrylic polymer as comprised within the at least one aqueous dispersion, as detailed above, said silane-modified acrylic polymer thereby further comprising recurring units derived from the monomer (Si), as detailed above, as used in the composition (C) of the present invention are generally well-known in the art.

Preferably, each of X in the monomer (Si) according to general formula (III) is independently selected from the group consisting of —CH═CH₂, —O—CO—CH═CH₂, and —O—CO—C(Me)=CH₂.

Preferably, each of R¹ in the monomer (Si) of general formula (III) is independently selected from the group consisting of C₁₋₁₀ alkyl, C₂₋₁₀ alkenyl, C₁₋₁₀ cycloalkyl, and C₆₋₁₀ aryl group. More preferably, each of R¹ is independently selected from C₁₋₅ alkyl, or C₁₋₈ cycloalkyl group. Even more preferably, each of R¹ is independently selected from the group consisting of methyl, ethyl, propyl, butyl, pentyl, isopropyl, isobutyl, tert-butyl, cyclopropyl, cyclobutyl, cyclopentyl, and cyclohexyl. More preferably, each of R¹ is independently selected from methyl, or ethyl.

Preferably, each of a in the monomer (Si) according to general formula (III) is an integer ranging from 0 to 1, more preferably each of a is 1.

Preferably, each of m in the monomer (Si) according to general formula (III) is an integer ranging from 0 to 4, more preferably each of m is an integer ranging from 0 to 3, even more preferably each of m is 1 or 3, most preferably each of m is 1.

As said, each of Y in the monomer (Si) of general formula (III) is a hydroxyl or a hydrolysable group.

When Y is a hydrolysable group, each of Y is independently selected from the group consisting of halogen atoms, alkoxy groups, acyloxy groups, ketoxymate groups, amino groups, amide groups, acid amide groups, aminooxy groups, mercapto groups, and alkenyloxy groups.

Non-limiting examples of alkoxy groups notably include methoxy, ethoxy, propoxy, butoxy group, and the like.

Preferably, each of Y is independently selected from the group consisting of alkoxy groups, acyloxy groups, ketoxymate groups, amino groups, amide groups, aminooxy groups, mercapto groups, and alkenyloxy groups.

More preferably, each of Y is an alkoxy group such as a methoxy, ethoxy, propoxy, butoxy group, and the like. Most preferably, each of Y is selected from a methoxy or an ethoxy group.

According to another embodiment of the composition (C) of the present invention, the acrylic polymer as comprised within the at least one aqueous dispersion, as detailed above, is a silane-modified acrylic polymer being a silyl-terminated acrylic polymer having at least one silyl end-group.

Suitable preparation methods of silyl-terminated acrylic polymers having silyl end-groups as used in the composition (C) of the present invention, are generally well-known in the art.

For example, silyl-terminated acrylic polymers can be obtained by an hydrosilylation reaction of an alkenyl-terminated acrylic polymer with an appropriate silylating component.

Suitable preparation methods of alkenyl-terminated acrylic polymers are generally known in the art. Reference can be made notably to U.S. Pat. No. 7,511,102 B2, the whole content of which is herein incorporated by reference.

Non-limiting examples of silylating components for hydrosilylation reactions with alkenyl-terminated acrylic polymers notably include, trichlorosilane, methyldichlorosilane, dimethylchlorosilane, phenyldichlorosilane, trimethoxysilane, triethoxysilane, methyldiethoxysilane, methyldimethoxysilane and phenyldimethoxysilane, methyldiacetoxysilane, phenyldiacetoxysilane, bis(dimethylketoximat)methylsilane, and bis(cyclohexylketoximat)methylsilane.

As said, the polymer (A) is comprised within at least one aqueous dispersion. Within the context of the present invention, the term “aqueous dispersion” is intended to refer to a system which contains polymer particles of the polymer (A), as detailed above, in disperse distribution as the disperse phase in an aqueous dispersing medium.

In principle, a person skilled in the art classifies aqueous dispersions as aqueous secondary dispersions and aqueous primary dispersions. The aqueous secondary dispersions are those in the preparation of which the polymer (A), as detailed above, is produced outside the dispersing medium, for example in solution in a suitable non-aqueous solvent. This solution is then transferred to the aqueous dispersing medium, and the solvent is separated off, as a rule by distillation, while dispersing is effected. In contrast, aqueous primary dispersions are those in which the polymer (A) is produced in the aqueous dispersing medium itself, directly as the disperse phase.

As said, the weight percent of the at least one aqueous dispersion, as detailed above, relative to the total weight of the composition (C), is from 5.00 to 80.00 wt. %.

Advantageously, the weight percent of the at least one aqueous dispersion, as detailed above, relative to the total weight of the composition (C), is advantageously equal to or less than 70.00 wt. %, preferably equal to or less than 60.00 wt. %, more preferably equal to or less than 55.00 wt. %, even more preferably equal to or less than 45.00 wt. %, most preferably equal to or less than 35.00 wt. %.

In a preferred embodiment of the composition (C) of the present invention, the weight percent of the at least one aqueous dispersion, as detailed above, relative to the total weight of the composition (C), ranges from 10.00 to 70.00 wt. %, preferably from 15.00 to 60.00 wt. %, more preferably from 20.00 to 55.00 wt. %, even more preferably from 20.00 to 45.00 wt. %, most preferably from 25.00 to 35.00 wt. %.

According to certain embodiments of the composition (C) of the present invention, the at least one aqueous dispersion comprising the polymer (A) has a total solids content from 30.00 to 80.00 wt. %, or from 35.00 to 75.00 wt. %, or from 40.00 to 70.00 wt. %, based on the total weight of the at least one aqueous dispersion.

The total solids content of the at least one aqueous dispersion as used in the composition (C) of the present invention can be measured according to a variety of techniques which are generally well-known in the art. Preferably, the total solids content of the at least one aqueous dispersion is measured according to the standard DIN EN ISO 3251:2019.

Advantageously, the weight percent of the polymer (A) as comprised in the at least one aqueous dispersion, as detailed above, relative to the total weight of the at least one aqueous dispersion, is equal to or greater than 30.00 wt. %, preferably equal to or greater than 40.00 wt. %, more preferably equal to or greater than 50.00 wt. %, even more preferably equal to or greater than 60.00 wt. %, most preferably equal to or greater than 70.00 wt. %.

In a preferred embodiment of the composition (C) of the present invention, the weight percent of the polymer (A) as comprised in the at least one aqueous dispersion, as detailed above, relative to the total weight of the at least one aqueous dispersion, ranges from 30.00 to 70.00 wt. %, preferably from 40.00 to 70.00 wt. %, more preferably from 50.00 to 70.00 wt. %, even more preferably from 55.00 to 70.00 wt. %, most preferably from 60.00 to 70.00 wt. %.

According to certain embodiments of the composition (C) of the present invention, the at least one aqueous dispersion further comprises one or more other components in order to stabilize the polymer (A) as comprised therein as to allow its effective dispersion in water. Non-limiting examples of these other components notably include external emulsifiers. Alternatively, this stabilization of the polymer (A) can also be achieved for example by chemically including hydrophilic centers in the (backbone of the) polymer (A) itself. Such hydrophilic centers may be one of three types: non-ionic, cationic and anionic hydrophilic groups or potentially hydrophilic groups. These hydrophilic groups or potentially hydrophilic groups fulfill the function as internal emulsifiers and make it possible to produce stable aqueous dispersions suitable for use in the composition (C) of the present invention.

Non-limiting examples of commercially available aqueous dispersions comprising acrylic polymers, as detailed above, suitable for use in the composition (C) of the present invention notably include: Acronal® V278, Acronal® S400 and Acronal® DS5036 X SIL available from BASF AG, Germany; VINNAPAS® EAF 380 available from Wacker Chemie AG; Bayhydrol® A 2546 available from Covestro.

Non-limiting examples of commercially available aqueous dispersions comprising silane-modified acrylic polymers having at least one silane group according to general formula (III), as detailed above, or silane-modified acrylic polymers being silyl-terminated acrylic polymers having at least one silyl end-group, as detailed above, suitable for use in the composition (C) of the present invention notably include: Acronal® DS5036 X SIL, Acronal® S 813 available from BASF AG, Germany; Texicryl®13-065 available from Scott Bader; Revacryl 385 available from Synthomer.

According to another embodiment of the composition (C) of the present invention, the polymer (A) as comprised within the at least one aqueous dispersion is a polyurethane, said polyurethane which can also comprise a silane-modified polyurethane.

Suitable preparation methods of aqueous dispersions comprising polyurethanes and/or silane-modified polyurethanes as the polymer (A) are well-known in the art.

Non-limiting examples of commercially available aqueous dispersions comprising polyurethanes suitable for use in the composition (C) of the present invention notably include: SILIKOPUR®8080, and SILIKOPUR®8081 available from Evonik; Witcobond® W-281F, Witcobond®358-95, Witcobond®363-02, Witcobond® W-170, Witcobond®737, Witcobond®386-51 available from Lanxess AG, Germany; DAOTAN® TW 6431/45WA available from Allnex; Luphen® D 259 U available from BASF AG, Germany; NeoRez® R-551 available from DSM.

According to another embodiment of the composition (C) of the present invention, the polymer (A) as comprised within the at least one aqueous dispersion is a polyvinyl ester, whereby the polyvinyl ester comprises recurring units derived from at least one vinyl ester monomer. Said polyvinyl ester can also comprise a silane-modified polyvinyl ester.

The term “at least one vinyl ester monomer”, as used herein, is understood to mean that the polyvinyl ester may comprise recurring units derived from one or more than one vinyl ester monomer, as described above. In the rest of the text, the expression “vinyl ester monomer” is understood, for the purposes of the present invention, both in the plural and the singular, that is to say that it denotes one or more than one vinyl ester monomer.

Non-limiting examples of suitable vinyl ester monomers notably include vinyl esters of branched or unbranched alkylcarboxylic acids having from 1 to 18 carbon atoms, examples being vinyl formate, vinyl acetate, vinyl propionate, vinyl butyrate, vinyl isobutyrate, vinyl valerate, vinyl pivalate, vinyl 2-ethylhexanoate, vinyl decanoate, isopropenyl acetate or 1-methylvinyl acetate; vinyl esters of saturated branched monocarboxylic acids having a tertiary carbon atom in the alpha position relative to the acid group and having 5 to 15 carbon atoms in the acid radical, examples being vinyl esters of the Versatic™ acids such as VeoVa5® (vinyl pivalate), VeoVa9®, VeoVa10® and VeoVa11® (trade names of Resolution Performance Products); vinyl esters of relatively long-chain saturated or unsaturated fatty acids, examples being vinyl laurate, vinyl stearate; and vinyl esters of benzoic acid and of substituted derivatives of benzoic acid, example being vinyl p-tert-butylbenzoate.

Preferably, the vinyl ester monomer is chosen from vinyl acetate, or vinyl esters of the Versatic™ acids.

According to certain embodiments of the composition (C) of the present invention, the polyvinyl ester, as detailed above, further comprises recurring units derived from other ethylenically unsaturated monomers.

Non-limiting examples of ethylenically unsaturated monomers mention maybe made of alkenes, such as ethylene, propylene, butylene, conjugated dienes, such as butadiene and isoprene and copolymers of butadiene and isoprene; aromatic vinyl monomers, such as styrene, vinyltoluene, α-methylstyrene, chlorostyrene, styrenesulfonic acid and its salts thereof; vinyl and halovinylidene monomers such as vinyl chloride, vinylidene chloride, vinyl fluoride and vinylidene fluoride; allyl esters, such as allyl acetate, allyl propionate, and allyl lactate; vinyl ethers, such as methyl vinyl ether, ethyl vinyl ether and n-butyl vinyl ether; vinyl ketones, such as methyl vinyl ketones, ethyl vinyl ketones and isobutyl vinyl ketones; maleic anhydride, maleic acid, and monoalkyl esters and dialkyl esters of maleic acid such as dimethyl maleate, diethyl maleate, dibutyl maleate, dioctyl maleate, diisooctyl maleate, dinonyl maleate, diisodecyl maleate, and ditridecyl maleate; fumaric acid and monoalkyl and dialkyl esters of fumaric acid such as dimethyl fumarate, diethyl fumarate, dipropyl fumarate, dibutyl fumarate, dioctyl fumarate, diisooctyl fumarate, and didecyl fumarate; maleimide monomers, such as maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide; acrylonitrile monomers, such as acrylonitrile and methacrylonitrile; amido-containing vinyl monomers, such as acrylamide and methacrylamide; and the like.

Non-limiting examples of suitable polyvinyl esters as comprised within the at least one aqueous dispersion for use in the composition (C) of the present invention notably include polyvinyl acetate, polyvinyl esters of Versatic™ acids, vinyl acetate-ethylene copolymers (VAE), vinyl acetate-ethylene-vinyl esters of the Versatic™ acids copolymers, and vinyl laurate-ethylene-vinyl chloride copolymers.

Suitable preparation methods of aqueous dispersions comprising polyvinyl esters and/or silane-modified polyvinyl esters as the polymer (A) are well-known in the art.

Non-limiting examples of commercially available aqueous dispersions comprising polyvinyl esters suitable for use in the composition (C) of the present invention notably include: VINNAPAS® CEZ 3031, VINNECO® EP 3360, VINNAPAS® EP 3360, VINNECO® EF 3777, VINNAPAS® EF 3777 available from Wacker Chemie AG; MOWILITH® MD 1025 available from Celanese.

According to another embodiment of the composition (C) of the present invention, the polymer (A) as comprised within the at least one aqueous dispersion is a polysiloxane, whereby the polysiloxane is a polymer of silicon oxide, having a backbone formed by alternating silicon and oxygen atoms. Sideways on this linear backbone, on each silicon atom of the silicon oxide polymer, are organic side groups, usually saturated organic groups, preferably methyl groups. Said polysiloxane can also comprise a silane-modified polysiloxane.

Suitable preparation methods of aqueous dispersions comprising polysiloxanes and/or silane-modified polysiloxanes as the polymer (A) are well-known in the art.

Non-limiting examples of commercially available aqueous dispersions comprising polysiloxanes suitable for use in the composition (C) of the present invention notably include: SILIKOPUR®8080, and SILIKOPUR® 8081 available from Evonik, DOWSIL™ HV 495 Emulsion available from The DOW® Chemical Company; NuSil® aqueous dispersions available from Avantor; aqueous silicone dispersions available from Elkem; PerformaSil™ 100 available from ICD.

### Redispersible Polymer Powder

As said above, the composition (C) comprises from 1.00 to 50.00 wt. % of at least one redispersible polymer powder, relative to the total weight of the composition (C).

The use of one or more redispersible polymer powders in aqueous compositions, suitable for use as a waterborne sealant and/or a waterborne adhesive, is for example known from US 2021/0221748 A1, DE 19742678 A1, JP 2001279205 A, and CN 106634716 A.

Generally, redispersible polymer powders are known to a person skilled in the art, in particular a person skilled in the art of mortars, and cement-based, i.e. cement-containing or cementitious construction and building materials.

Within the context of the present invention, the term “redispersible polymer powder” is intended to refer to (co)polymers which can be obtained as a water-based dispersion by appropriate polymerization processes well known in the industry, such as (inverse) (micro)emulsion and suspension polymerization processes, whereby said (co)polymers are converted into a free flowing polymer powder in a further step by suitable and conventional drying measures such as spray drying, pulse combustion spray drying, freeze drying, coagulation of the water-based dispersion and subsequent fluidized-bed drying, drum drying, flash drying, eventually by using high temperatures and pressures.

Preferably, the (co)polymers as the water-based dispersion are converted into the free flowing polymer powder by spray drying. Upon remixing into water or aqueous systems, the redispersible polymer powder easily forms a water-based dispersion again with essentially identical properties to the original water-based dispersion, hence the term redispersible polymer powder.

According to a preferred embodiment of the composition (C) of the present invention, the at least one redispersible polymer powder is a (co)polymer derived from at least one ethylenically unsaturated monomer selected from the group consisting of vinyl aromatic monomers, vinyl halide monomers, vinyl ester monomers of branched or unbranched alkylcarboxylic acids having from 1 to 15 carbon atoms, (meth)acrylic ester monomers of branched or unbranched alcohols having from 1 to 10 carbon atoms, olefin monomers, and diene monomers.

The term “at least one ethylenically unsaturated monomer”, as used herein, is understood to mean that the redispersible polymer powder may comprise recurring units derived from one or more than ethylenically unsaturated monomer, as described above. In the rest of the text, the expression “ethylenically unsaturated monomer” is understood, for the purposes of the present invention, both in the plural and the singular, that is to say that it denotes one or more than one ethylenically unsaturated monomer.

Preferred vinyl aromatic monomers are selected from the group consisting of styrene, vinyltoluene, and α-methylstyrene.

Preferred vinyl halide monomers are selected from vinyl chloride, and vinylidene chloride.

Preferred vinyl ester monomers of branched or unbranched alkylcarboxylic acids having from 1 to 15 carbon atoms are selected from the group consisting of vinyl acetate, vinyl propionate, vinyl butyrate, vinyl 2-ethyl-hexanoate, 1-methylvinyl acetate, vinyl laurate, and vinyl ester monomers of monocarboxylic acids which have a tertiary carbon atom in the alpha position relative to the acid group and have from 5 to 11 carbon atoms (vinyl versatates), for example VeoVa5® (vinyl pivalate), VeoVa9®, VeoVa10® and VeoVa11® (trade names of Resolution Performance Products).

Particularly preferred vinyl ester monomers of branched or unbranched alkylcarboxylic acids having from 1 to 15 carbon atoms are vinyl acetate and the vinyl versatates, as detailed above.

Preferred (meth)acrylic ester monomers of branched or unbranched alcohols having from 1 to 10 carbon atoms are selected from the group consisting of methyl (meth)acrylate, ethyl(meth)acrylate, propyl(meth)acrylate, n-butyl(meth)acrylate, and 2-ethylhexylacrylate.

Preferred olefin monomers are selected from the group consisting of ethylene, propylene, 1-butene, and 2-methylpropene.

A particularly preferred olefin monomer is ethylene.

Preferred diene monomers are selected from 1,3-butadiene, or isoprene.

According to the composition (C) of the present invention, preference is given to the following types of the at least one redispersible polymer powder as explained in detail below, with the figures for the respective monomers being wt. % relative to the total weight of the at least one redispersible polymer powder and, if appropriate together with further monomer units, adding up to 100.0 wt.

According to one embodiment of the composition (C) of the present invention, when the redispersible polymer powder, as detailed above, is a (co)polymer derived vinyl aromatic monomers, the redispersible polymer powder is preferably selected from styrene-butadiene copolymers; or styrene-acrylic ester copolymers such as styrene-n-butyl acrylate or styrene-2-ethylhexylacrylate having a styrene content of in each case from 10.0 to 70.0 wt. %.

According to one embodiment of the composition (C) of the present invention, when the redispersible polymer powder, as detailed above, is a (co)polymer derived vinyl halide monomers, the redispersible polymer powder is preferably selected from the group consisting of vinyl ester-ethylene-vinyl chloride copolymers; vinyl chloride-ethylene copolymers; and vinyl chloride-acrylate copolymers.

According to another embodiment of the composition (C) of the present invention, when the redispersible polymer powder, as detailed above, is a (co)polymer derived from vinyl ester monomers of branched or unbranched alkylcarboxylic acids having from 1 to 15 carbon atoms, the redispersible polymer powder is preferably selected from the group consisting of vinyl acetate polymers which may be partially hydrolyzed; vinyl acetate-ethylene (VAE) copolymers having an ethylene content of from 1.0 to 60.0 wt. %; vinyl acetate copolymers with from 1.0 to 50.0 wt. % of one or more further vinyl ester monomers such as vinyl laurate, vinyl pivalate and in particular vinyl versatates VeoVa9®, VeoVa10® and VeoVa11® (trade names of Resolution Performance Products) with these copolymers being able to contain from 1.0 to 40.0 wt. % of ethylene as further monomer; vinyl ester-ethylene-vinyl chloride copolymers having an ethylene content of from 1.0 to 40.0 wt. % and a vinyl chloride content of from 20.0 to 90.0 wt. % (possible vinyl esters are, for example, vinyl acetate, vinyl propionate, vinyl butyrate, vinyl 2-ethyl-hexanoate, 1-methylvinyl acetate, vinyl laurate and vinyl esters of monocarboxylic acids which have a tertiary carbon atom in the alpha position relative to the acid group and have from 5 to 11 carbon atoms (vinyl versatates), for example VeoVa5® (vinyl pivalate), VeoVa9®, VeoVa10® and VeoVa11® (trade names of Resolution Performance Products)); and vinyl acetate-acrylic ester copolymers which contain from 1.0 to 60.0 wt. % of acrylic ester, preferably n-butyl acrylate, and may additionally contain from 1.0 to 40.0 wt. % of ethylene.

According to another embodiment of the composition (C) of the present invention, when the redispersible polymer powder, as detailed above, is a (co)polymer derived from (meth)acrylic ester monomers of branched or unbranched alcohols having from 1 to 10 carbon atoms, the redispersible polymer powder is preferably selected from the group consisting of copolymers derived from the monomer units n-butyl acrylate and/or 2-ethylhexylacrylate; copolymers derived from of methyl methacrylate with n-butyl acrylate and/or 2-ethyl-hexylacrylate; and copolymers derived from methyl methacrylate with 1,3-butadiene.

According to a preferred embodiment of the composition (C) of the present invention, the redispersible polymer powder, as detailed above, is selected from the group consisting of vinyl acetate polymers; vinyl acetate-ethylene copolymers having an ethylene content of from 1.0 to 60.0 wt. %; vinyl acetate copolymers with from 1.0 to 50.0 wt. % of one or more further vinyl ester monomers such as vinyl laurate, vinyl pivalate, and in particular ®Vinyl versatates such as VeoVa9®, VeoVa10® and VeoVa11® (trade names of Resolution Performance Products), with these copolymers being able to contain from 1.0 to 40.0 wt. % of ethylene as further monomer; vinyl acetate-acrylic ester copolymers which contain from 1.0 to 60.0 wt. % of acrylic ester, preferably n-butyl acrylate, and which may contain from 1.0 to 40.0 wt. % of ethylene; vinyl ester-ethylene-vinyl chloride copolymers; vinyl chloride-ethylene copolymers; styrene-butadiene copolymers; and styrene-acrylic ester copolymers such as styrene-n-butyl acrylate or styrene-2-ethylhexylacrylate having a styrene content of in each case from 10.0 to 70.0 wt. %.

According to a more preferred embodiment of the composition (C) of the present invention, the redispersible polymer powder, as detailed above, is selected from the group consisting of vinyl acetate polymer; vinyl acetate-ethylene copolymer; vinyl acetate-vinyl ester copolymer and vinyl acetate-vinyl ester-ethylene copolymer, with the vinyl ester monomers being selected in each case from the group consisting of vinyl laurate, vinyl pivalate and vinyl versatates; vinyl acetate-acrylic ester copolymer; vinyl acetate-acrylic ester-ethylene copolymer; styrene-butadiene copolymer; and styrene-acrylic ester copolymer, with the acrylic esters in each case being esters of branched or unbranched alcohols having from 1 to 10 carbon atoms.

Optionally, the redispersible polymer powder can additionally comprise functional comonomer units in an amount of 0.1 to 10.0 wt. %, relative to the total weight of the redispersible polymer powder. Non-limiting examples of such functional comonomer units notably include monocarboxylic or dicarboxylic acids, for example (meth)acrylic acid and/or maleic acid; carboxamides such as (meth)acrylamide; sulphonic acids and salts thereof, for example vinylsulphonic acid and/or styrene-sulphonic acid; multiply ethylenically unsaturated comonomers, for example divinyl adipate, triallyl isocyanurate, diallylmaleate and/or allyl methacrylate.

According to the composition (C) of the present invention, the redispersible polymer powder may have an average particle size of from 20 microns to 150 microns, preferably from 20 microns to 90 microns, most preferably from 50 microns to 80 microns.

Non-limiting examples of commercially available redispersible polymer powders suitable for use in the composition (C) of the present invention notably include VINNAPAS®8034 H, VINNAPAS®5048 H, VINNAPAS®7055 E available from Wacker Chemie AG; Acronal P 5466 X, Acronal® S 430 P available from BASF AG.

The inventors have surprisingly found that by using specific amounts of the redispersible polymer powder, as detailed above, the resulting composition (C), suitable for use as a waterborne sealant and/or a waterborne adhesive, has a high solids content level, thereby further demonstrating, in the cured state, a reduction of shrinkage, while maintaining or improving other mechanical properties such as elastic recovery, elongation at break, high or low modulus, and adhesion, as detailed in the experimental section below.

Advantageously, the weight percent of the redispersible polymer powder, as detailed above, relative to the total weight of the composition (C), is equal to or greater than 2.00 wt. %, preferably equal to or greater than 2.50 wt. %, more preferably equal to or greater than 3.00 wt. %, even more preferably equal to or greater than 3.50 wt. %, yet even more preferably equal to or greater than 4.00 wt. %, most preferably equal to or greater than 4.50 wt. %.

It is further understood that the upper limit of the amount of the redispersible polymer powder, as detailed above, relative to the total weight of the composition (C), is equal to or less than 40.00 wt. %, preferably equal to or less than 35.00 wt. %, preferably equal to or less than 30.00 wt. %, preferably equal to or less than 25.00 wt. %, preferably equal to or less than 20.00 wt. %, more preferably equal to or less than 15.00 wt. %.

In a preferred embodiment of the composition (C) of the present invention, the weight percent of the redispersible polymer powder, as detailed above, relative to the total weight of the composition (C), ranges from 2.00 to 40.00 wt. %, preferably from 2.50 to 35.00 wt. %, more preferably from 3.00 to 30.00 wt. %, even more preferably from 3.50 to 25.00 wt. %, yet even more preferably from 4.00 to 20.00 wt. %, most preferably from 4.50 to 15.00 wt. %.

### Filler

As said above, the composition (C) comprises from 5.00 to 70.00 wt. % of at least one filler, relative to the total weight of the composition (C).

Suitable fillers for use in the composition (C) of the present invention are generally known in the art and may notably include natural, grounded or precipitated calcium carbonates which are optionally coated with fatty acids, especially stearic acid and stearates, or fatty acid esters; talc; terra alba; silica such as fumed silica, precipitated silica, crystalline silica, molten silica, fused silica, silicic anhydride, aqueous silicic acid, and amorphous spherical silica; mica; carbon black; graphite; bitumen; magnesium carbonate; diatomaceous earth; dolomites; molochites; zeolites; sand; clay; calcined clay; white clay; bentonite; organic bentonite; kaolin; calcined kaolin; montmorillonite; wollastonite; quartz powder; walnut shell powder; chaff powder; rice hull flour; wood flour; wood chips; chopped straw; pulp; cotton chip; lignin; titanium oxide; ferric oxide; colcothar; iron powder; aluminum oxide; aluminum hydroxide; aluminum powder; zinc oxide; active zinc oxide; zinc powder; zinc carbonate; zirconium oxide; magnesium hydroxide; barite or heavy spar; gypsum; flint powder; balloon; solid beads such as solid glass spheres; resin powders such as polyvinyl chloride (PVC) powder or polymethyl-methacrylate (PMMA) powder; hollow beads; organic fibers thereby including synthetic fibers such as aramid fibers, polyethylene fibers, polypropylene fibers, polyester fibers, polyamide fibers, and natural fibers such as straw, paper fiber, wood, wool, cotton, silk, flax, hemp, jute, and sisal; and inorganic fibers and filaments such as carbon fibers, glass fibers, and glass filaments.

For the purpose of the present invention, balloon as a suitable filler may notably include an organic balloon filler and an inorganic balloon filler. In general, balloon as a filler is known in the art of sealants and adhesives as a spherical filler of which inside is hollow. Non-limiting examples of inorganic balloon fillers notably include glass balloon, Shirasu balloon, perlite balloon, fly ash balloon, alumina balloon, zirconia balloon, and carbon balloon. Non-limiting examples of organic balloon fillers notably include thermosetting resin balloons and thermoplastic resin balloons. Suitable examples of thermosetting resin balloons notably include phenolic balloon, epoxy balloon, and urea balloon. Suitable examples of thermoplastic resin balloons notably include poly(vinylidene chloride) balloon, polystyrene balloon, polymethacrylate balloon, poly(vinyl alcohol) balloon, and styrene-acrylic balloon.

Non limitative examples of commercially available fillers suitable for use in the method of the present invention include: the ImerSeal™ series available from Imerys; the Hubercarb® and Hymod® series available from Huber Engineered Materials; the KaMin™ series available from KaMin; Omyacarb 2GU, and Microdol A200 available from Omya; Imercarb® 11 and Imercarb® 22 available from Imerys.

According to a preferred embodiment of the composition (C) of the present invention, the filler, as detailed above, is selected from the group consisting of natural, grounded or precipitated calcium carbonates which are optionally coated with fatty acids, or fatty acid esters; talc; silica such as fumed silica, precipitated silica, crystalline silica, molten silica, fused silica, silicic anhydride, aqueous silicic acid, and amorphous spherical silica; carbon black; dolomites; clay; calcined clay; kaolin; calcined kaolin; montmorillonite; wollastonite; titanium oxide; aluminum oxide; aluminum hydroxide; magnesium hydroxide; gypsum; balloon; solid beads such as solid glass spheres; and hollow beads.

According to a more preferred embodiment of the composition (C) of the present invention, the filler, as detailed above, is selected from the group consisting of natural, grounded or precipitated calcium carbonates which are optionally coated with fatty acids, or fatty acid esters; talc; silica such as fumed silica, precipitated silica, crystalline silica, molten silica, fused silica, silicic anhydride, aqueous silicic acid, and amorphous spherical silica; carbon black; dolomites; clay; calcined clay; and titanium oxide.

According to an even more preferred embodiment of the composition (C) of the present invention, the filler, as detailed above, is selected from the group consisting of natural, grounded or precipitated calcium carbonates which are optionally coated with fatty acids, or fatty acid esters; dolomites; and titanium oxide. Most preferably, the filler is natural, grounded or precipitated calcium carbonates which are optionally coated with fatty acids, or fatty acid esters.

According to another preferred embodiment of the composition (C) of the present invention, when the filler is natural, grounded or precipitated calcium carbonate, which are optionally coated with fatty acids, or fatty acid esters, the natural, grounded or precipitated calcium carbonate has a particle size D₅₀ equal to or less than 70.0 μm, preferably equal to or less than 50.0 μm, preferably equal to or less than 30.0 μm, preferably equal to or less than 20.0 μm, preferably equal to or less than 10.0 μm, preferably equal to or less than 8.0 μm, preferably equal to or less than 6.0 μm, preferably equal to or less than 5.0 μm, preferably equal to or less than 4.0 μm, preferably equal to or less than 3.0 μm, more preferably equal to or less than 2.0 μm.

For example, D₅₀≤10.0 μm denotes that 50 wt. % of the particles of the natural, grounded or precipitated calcium carbonate, as detailed above, has a particle size equal to or less than 10.0 μm.

According to the present invention, the particle size of the particles of the natural, grounded or precipitated calcium carbonate, as detailed above, is measured according to DIN ISO 13320(:2020).

The inventors have surprisingly found that by using specific amounts of the filler, as detailed above, in presence of the polymer (A), as detailed above, and particularly in the presence of the redispersible polymer powder, as detailed above, the resulting composition (C), suitable for use as a waterborne sealant and/or a waterborne adhesive, has a high solids content level, thereby further demonstrating, in the cured state, a reduction of shrinkage, while maintaining or improving other mechanical properties such as elastic recovery, elongation at break, high or low modulus, and adhesion, as detailed in the experimental section below. Therefore, the filler as comprised in the composition (C) may not only influence the rheological properties of the uncured composition (C) but also the mechanical properties and the surface nature and quality of the cured composition (C), obtainable from the composition (C), as detailed in the experimental section below.

Advantageously, the amount of the filler, as detailed above, relative to the total weight of the composition (C), is equal to or greater than 10.00 wt. %, preferably equal to or greater than 15.00 wt. %, preferably equal to or greater than 20.00 wt. %, preferably equal to or greater than 25.00 wt. %, preferably equal to or greater than 30.00 wt. %, more preferably equal to or greater than 35.00 wt. %.

It is further understood that the upper limit of the amount of the filler, as detailed above, relative to the total weight of the composition (C), is equal to or less than 67.00 wt. %, preferably equal to or less than 65.00 wt. %, preferably equal to or less than 63.00 wt. %, preferably equal to or less than 60.00 wt. %, preferably equal to or less than 57.00 wt. %, more preferably equal to or less than 55.00 wt. %.

In a preferred embodiment according to the present invention, the filler, as detailed above, relative to the total weight of the composition (C), is present in an amount from 10.00 to 67.00 wt. %, preferably from 15.00 to 65.00 wt. %, preferably from 20.00 to 63.00 wt. %, preferably from 25.00 to 60.00 wt. %, preferably from 30.00 to 57.00 wt. %, more preferably from 35.00 to 55.00 wt.

According to an embodiment of the present invention, the redispersible polymer powder, as detailed above, and the filler, as detailed above, are comprised in the composition (C), as detailed above, in an amount as determined by a dry weight ratio of the redispersible polymer powder to the filler, said dry weight ratio being equal to or lower than 10.0:1.0, preferably equal to or lower than 5.0:1.0, preferably equal to or lower than 1.0:1.0, preferably equal to or lower than 0.5:1.0, more preferably equal to or lower than 0.1:1.0.

### Other Components

According to certain embodiments of the present invention, the composition (C), as detailed above, further comprises at least one crosslinking agent.

Within the context of the present invention, the expression “at least one crosslinking agent” is intended to denote one or more than one crosslinking agent. Mixtures of crosslinking agents can also be used for the purpose of the invention.

It is generally understood that the at least one crosslinking agent serves the purpose of crosslinking the polymer (A), as detailed above, and/or the redispersible polymer powder, as detailed above. This is particularly advantageous when the polymer (A) and/or the redispersible polymer powder contain carboxyl(ate) functional groups.

Non-limiting examples of suitable crosslinking agents notably include zinc oxide, oxazolines, polyisocyanates, aziridines, and silanes such as Silquest A-187 available from Momentive Performance Materials.

Advantageously, when present, the weight percent of the crosslinking agent, as detailed above, relative to the total weight of the composition (C), is equal to or greater than 0.01 wt. %.

It is further understood that, the weight percent of the crosslinking agent, as detailed above, relative to the total weight of the composition (C), is advantageously equal to or less than 3.00 wt. %, preferably equal to or less than 2.00 wt. %, more preferably equal to or less than 1.00 wt. %, even more preferably equal to or less than 0.70 wt. %, most preferably equal to or less than 0.5 wt. %.

In a preferred embodiment of the composition (C) of the present invention, the weight percent of the crosslinking agent, as detailed above, relative to the total weight of the composition (C), ranges from 0.01 to 3.00 wt. %, preferably from 0.01 to 2.00 wt. %, more preferably from 0.01 to 1.00 wt. %, even more preferably from 0.01 to 0.70 wt. %, most preferably from 0.01 to 0.50 wt.

According to certain embodiments of the present invention, the composition (C), as detailed above, further comprises at least one surfactant, emulsifier, or emulsifying agent. The terms “surfactant”, “emulsifier”, and “emulsifying agent” are used interchangeably herein.

Within the context of the present invention, the expression “at least one surfactant” is intended to denote one or more than one surfactant. Mixtures of surfactants can also be used for the purpose of the invention. In the remainder of the text, the term “surfactant” is understood, for the purposes of the invention both in the plural and the singular form.

When present in the composition (C), as detailed above, the surfactant can desirably be used to stabilize the composition (C) so that the mixture maintains one single phase.

Within the context of the present invention, the term “surfactant” is intended to refer to anionic, cationic, zwitterionic or non-ionic surfactants.

Non-limiting examples of suitable anionic surfactants notably include sulfate-type anionic surfactants such as polyoxyethylene alkyl ether sulfates, alkyl aryl sulfates, long-chain alcohol sulfates and sodium, potassium, ammonium and other salts thereof, for example ammonium lauryl sulfate, sodium lauryl sulfate, potassium lauryl sulfate, sodium dodecyl sulfate, sodium laureth sulfate, sodium myreth sulfate; sulfonic acid-type anionic surfactants such as alkylsulfonic acids, alkylbenzenesulfonic acids, alkylnaphthalenesulfonic acids, paraffinsulfonic acids, α-olefinsulfonic acids, alkylsulfosuccinic acids, and sodium, potassium ammonium and other salts thereof, for example dioctyl sodium sulfosuccinate, perfluorooctanesulfonate, perfluorobutanesulfonate, dodecylbenzenesulfonate; alkyl aryl ether phosphates and alkyl ether phosphates.

Non-limiting examples of suitable cationic surfactants notably include dodecyl ammonium chloride, dodecyl ammonium bromide, dodecyl trimethyl ammonium bromide, dodecyl pyridinium chloride, dodecyl pyridinium bromide, hexadecyl trimethyl ammonium bromide, cetrimonium bromide, cetylpyridinium chloride, benzalkonium chloride, benzethonium chloride, dimethyldioctadecylammonium chloride, and dioctadecylmethylammonium bromide.

Non-limiting examples of suitable zwitterionic surfactants notably include alkyl dimethyl betaine, alkylamido betaine, alkyl amide betaine, alkylamidopropyl betaine, alkyl dimethylammonium betaine, alkyl amidopropyl betaine, alkyl sulfobetaine; alkyl, alkylampho glycinate, alkylamphocarboxy glycinate, alkyl or alkyl substituted imidazoline monocarboxylate, alkyl or alkyl substituted imidazoline dicarboxylate, sodium salts of alkyl monocarboxylates, sodium salts of alkyl monocarboxylates, alkyl beta amino acids, alkyl amidopropyl hydroxysultaine, alkyl ether hydroxysultaine, alkyl amidopropyl dimethyl ammonia acetate, alkyl ampho monoacetate, alkyl ampho diacetate, alkyl dipropionate, alkyl ampho dipropionate, alkyl imino dipropionate, alkyl amphopropionate, alkyl beta amino propionic acid, alkyl dipropionate, alkyl beta iminodipropionate, branched or n-alkyl dimethylamidopropionate, alkyl carboxylated propionate, alkyl imidazoline, methyl alkyl imidazoline, alkyldimethylamine oxides wherein the alkyl chain preferably has from 6 to 16 carbon atoms, and fluorinated alkyl amphoteric mixtures.

Non-limiting examples of suitable non-ionic surfactants notably include poly-oxyethylenedodecyl ether, polyoxyethylene hexadecyl ether, polyoxyethylenenonylphenyl ether, polyoxyethylenelauryl ether, polyoxyethylene Sorbitan monoleate ether, and monodecanoyl sucrose.

Preferably, the surfactant for use in the composition (C) of the present invention is an anionic surfactant, as detailed above, or a zwitterionic surfactant as detailed above.

More preferably, the surfactant for use in the composition (C) of the present invention is an anionic surfactant, as detailed above.

As to the amount of the surfactant it is understood that the skilled person in the art will practise said surfactant in a suitable amount according to the standard and general practice known by said skilled person in the art.

Advantageously, when present, the weight percent of the surfactant, as detailed above, relative to the total weight of the composition (C), is equal to or greater than 0.01 wt. %.

It is further understood that, the weight percent of the surfactant, as detailed above, relative to the total weight of the composition (C), is advantageously equal to or less than 0.30 wt. %, preferably equal to or less than 0.20 wt. %, more preferably equal to or less than 0.10 wt. %, even more preferably equal to or less than 0.05 wt. %.

In a preferred embodiment of the composition (C) of the present invention, the weight percent of the surfactant, as detailed above, relative to the total weight of the composition (C), ranges from 0.01 to 0.30 wt. %, preferably from 0.01 to 0.20 wt. %, more preferably from 0.01 to 0.10 wt. %, even more preferably from 0.01 to 0.05 wt. %.

According to certain embodiments of the present invention, the composition (C), as detailed above, further comprises at least one plasticizer.

Within the context of the present invention, the expression “at least one plasticizer” is intended to denote one or more than one plasticizer. Mixtures of plasticizers can also be used for the purpose of the invention. In the remainder of the text, the term “plasticizer” is understood, for the purposes of the invention both in the plural and the singular form.

Suitable plasticizers for use in the composition (C) of the present invention are notably described in US 2014/0094553 A1.

Among plasticizers suitable for use in the composition (C) of the present invention, mention may be notably made of phthalic acid ester compounds such as dibutyl phthalate, diisononyl phthalate (DINP), diheptyl phthalate, di(2-ethylhexyl)phthalate, diisodecyl phthalate (DIDP), and butyl benzyl phthalate; terephthalic acid ester compounds such as bis(2-ethylhexyl)-1.4-benzenedicarboxylate; non-phthalic ester compounds such as 1,2-cyclohexane dicarboxylic acid diisononyl ester, aliphatic polycarboxylic acid ester compounds such as dioctyl adipate, dioctyl sebacate, dibutyl sebacate, diisodecyl succinate, and tributyl acetylcitrate; unsaturated fatty acid ester compounds such as butyl oleate and methyl acetyl ricinoleate; alkyl sulfonic acid phenyl esters; phosphoric acid ester compounds such as tricresyl phosphate and tributyl phosphate; trimellitic acid ester compounds; chlorinated paraffin; hydrocarbon oils such as alkyl diphenyl and partially hydrogenated terphenyl; process oil; and epoxy plasticizers such as epoxidized soybean oil and benzyl epoxystearate. Also, polymer plasticizers may be used as plasticizers (PL) suitable for use in the composition (C) of the present invention, such as but not particularly limited to, vinyl polymers obtained by polymerizing vinyl monomers by various methods; esters of polyalkylene glycols, such as diethylene glycol dibenzoate, triethylene glycol dibenzoate, and pentaerythritol ester; polyester plasticizers formed from dibasic acids (e.g. sebacic acid, adipic acid, azelaic acid, phthalic acid) and divalent alcohols (e.g. ethylene glycol, diethylene glycol, triethylene glycol, propylene glycol, dipropylene glycol); polyethers such as polyether polyols (e.g. polyethylene glycol, polypropylene glycol, and polytetramethylene glycol having a number average molecular weight of 500 or more, or even 1000 or more) and derivatives obtained by converting the hydroxyl groups of these polyether polyols into ester groups, ether groups, or the like; polystyrenes such as polystyrene and poly-α-methylstyrene; polybutadiene, polybutene, polyisobutylene, butadieneacrylonitrile, polychloroprene; fatty acid alkyl esters, alkylsulfonic esters of phenol, mineral oils, plasticizers based on renewable raw materials, such as such as rapeseed oil, soybean oil, and palm oil, and esters, especially methyl esters, of vegetable oils, such as rapeseed oil methyl ester, soya methyl ester, and palm oil methyl ester.

The composition (C), however, is preferably free from phthalate-containing compounds, meaning that the composition (C) is, in particular, free from phthalate-containing plasticizers, which are typically employed in the sealants according to the prior or art.

Non-limiting examples of commercially available plasticizers suitable for use in the composition (C) of the present invention notably include: Eastman 168™ available from the Eastman Chemical Company; Jayflex™ DINP, Jayflex™ DIUP, Jayflex™ DIDP available from ExxonMobil Chemical; Mesamoll™ available from Lanxess; Hexamoll® DINCH, OPPANOL® PIB available from BASF AG; Desmophen®2060 BD available from Covestro; VORANOL™ available from The DOW® Chemical Company; Indopol® H-300 available from Ineos.

Typically, the amount of the plasticizer, when present in the composition (C), as detailed above, is from 1.00 to 80.00 wt. %, more preferably from 5.00 to 70.00 wt. %, most preferably from 7.00 to 50.00 wt. %, relative to the total weight of the composition (C).

According to certain embodiments of the present invention, the composition (C), as detailed above, further comprises at least one rheology modifier, thickener, or thickening agent. The terms “rheology modifier”, “thickener”, and “thickening agent” are used interchangeably herein.

Within the context of the present invention, the expression “at least one rheology modifier” is intended to denote one or more than one rheology modifier. Mixtures of rheology modifiers can also be used for the purpose of the invention. In the remainder of the text, the term “rheology modifier” is understood, for the purposes of the invention both in the plural and the singular form.

Among rheology modifiers suitable for use in the composition (C) of the present invention, mention may be notably made of phyllosilicates such as bentonites; polyacrylic acid polymers and copolymers; polyurethanes; urea compounds; mono-amines such as n-butylamine, methoxybutylamine; pyrogenic (fumed) silicas; cellulose ethers; or hydrophobically modified polyoxyethylenes.

Non-limiting examples of commercially available rheology modifiers suitable for use in the composition (C) of the present invention notably include: TAFIGEL® PUR 60 available from Munzing; Bentone EW available from KAWA International; Aerosil® R974, and Aerosil® 200 available from Evonik Industries; RHEOVIS® PU 1191, RHEOVIS® HS1162, and RHEOVIS® AS1130 available from BASF AG; and AQUAFLOW NLS-200 available from Brenntag.

Typically, the amount of the rheology modifier, when present in the composition (C), as detailed above, is from 0.01 to 3.00 wt. %, more preferably from 0.01 to 2.00 wt. %, most preferably from 0.01 to 1.00 wt. %, relative to the total weight of the composition (C).

According to certain embodiments of the present invention, the composition (C), as detailed above, further comprises at least one dispersing agent, or dispersant. The terms “dispersing agent”, and “dispersant” are used interchangeably herein.

Within the context of the present invention, the expression “at least one dispersing agent” is intended to denote one or more than one dispersing agent. Mixtures of dispersing agents can also be used for the purpose of the invention. In the remainder of the text, the term “dispersing agent” is understood, for the purposes of the invention both in the plural and the singular form.

When present in the composition (C), as detailed above, the surfactant can desirably be used to improve the compatibility of the filler, as detailed above, and/or the plasticizer, as detailed above, and to achieve manageable viscosities of the composition (C), as detailed above.

Non-limiting examples of suitable dispersing agents notably include sodium polyacrylate, and ammonium polyacrylate (co)polymers.

Non-limiting examples of commercially available dispersing agents suitable for use in the composition (C) of the present invention notably include Dispex® N40, Dispex® CX 4231, and Dispex® PX 4575 available from BASF AG, Germany.

As to the amount of the dispersing agent it is understood that the skilled person in the art will practise said dispersing agent in a suitable amount according to the standard and general practice known by said skilled person in the art.

Advantageously, the weight percent of the dispersing agent, as detailed above, relative to the total weight of the composition (C), is equal to or greater than 0.05 wt. %, preferably equal to or greater than 0.10 wt. %, more preferably equal to or greater than 0.15 wt. %, even more preferably equal to or greater than 0.20 wt. %, most preferably equal to or greater than 0.25 wt. %.

It is further understood that, the weight percent of the dispersing agent, as detailed above, relative to the total weight of the composition (C), is advantageously equal to or less than 3.00 wt. %, preferably equal to or less than 2.50 wt. %, more preferably equal to or less than 2.00 wt. %, even more preferably equal to or less than 1.50 wt. %, most preferably equal to or less than 1.00 wt. %.

In a preferred embodiment of the composition (C) of the present invention, the weight percent of the dispersing agent, as detailed above, relative to the total weight of the composition (C), ranges from 0.05 to 3.00 wt. %, preferably from 0.10 to 2.50 wt. %, more preferably from 0.15 to 2.00 wt. %, even more preferably from 0.20 to 1.50 wt. %, most preferably from 0.25 to 1.00 wt.

According to certain embodiments, the composition (C) according to the present invention, may comprise at least one other additional ingredient [ingredient (I_{C}), herein after] to enhance the appearance, storage, transport, handling and/or performance of the composition (C).

Within the context of the present invention, the expression “at least one other additional ingredients [ingredient (I_{C}), herein after]” is intended to denote one or more than one ingredient (I_{C}). Mixtures of ingredients (I_{C}) can also be used for the purpose of the invention. In the remainder of the text, the expression “ingredient (I_{C})” is understood, for the purposes of the present invention, both in the plural and the singular form.

Said ingredients (I_{C}) are known to those skilled in the art of adhesive/sealant compositions. Non-limiting examples of ingredients (I_{C}) notably include: stabilizers to protect from light, heat and/or UV-radiation; blowing agents; solvents; flame retardants; pigments; curability modifiers; radical inhibitors; metal deactivators; antiozonants; antioxidants; phosphorus peroxide decomposers; lubricants; adhesion promoters and crosslinkers such as epoxysilanes, (meth)acrylsilanes, anhydrosilanes or hydroxyl functional silanes such as described notably in WO 2009/130298 A1 and WO 2014/187865 A1; moisture scavengers such as vinyltrimethoxysilane, α-functional silanes such as N-(silylmethyl)-O-methylcarbamates, for example, N-(methyldimethoxysilylmethyl)-O-methyl carbamate, (methacryloxymethyl)silanes, methoxymethylsilanes, N-phenyl-, N-cyclohexyl- and N-alkyl silanes, ortho formic acid esters, calcium oxide or molecular sieves; surface-active substances such as wetting agents, leveling agents, air release agents or defoamers; biocides such as algicides, fungicides or fungal growth inhibitors; and other substances typically used in moisture-curing compositions.

Typically, the amount of the ingredient (I_{C}), when present, is from 0.05 to 20.00 wt. %, more preferably from 0.10 to 10.00 wt. %, most preferably from 0.10 to 5.00 wt. %, relative to the total weight of the composition (C).

The composition (C), as detailed above, suitable for use as a waterborne sealant and/or a waterborne adhesive, is stable and can be stored for longer time at room temperature. The total solids content, as measured according to the standard DIN EN ISO 3251:2019, can reach from 75.0 to 95.0 wt. %, preferably from 80.0 to 90.0 wt. %, relative to the total weight of the composition (C).

Preferably, the composition (C), as detailed above, is free from organic solvents.

According to a preferred embodiment of the present invention, the composition (C), as detailed above, comprises, relative to the total weight of the composition (C):
from 5.00 to 80.00 wt. % of at least one aqueous dispersion comprising at least one polymer (A) being an acrylic polymer, whereby the acrylic polymer comprises recurring units derived from at least one (meth)acrylic acid monomer or/and at least one (meth)acrylic acid ester monomer;
from 1.00 to 50.00 wt. % of at least one redispersible polymer powder being a a (co)polymer derived from at least one ethylenically unsaturated monomer selected from the group consisting of vinyl aromatic monomers, vinyl halide monomers, vinyl ester monomers of branched or unbranched alkylcarboxylic acids having from 1 to 15 carbon atoms, (meth)acrylic ester monomers of branched or unbranched alcohols having from 1 to 10 carbon atoms, olefin monomers, and diene monomers;
from 5.00 to 70.00 wt. % of at least one filler;
optionally at least one crosslinking agent;
optionally at least one surfactant;
optionally at least one plasticizer;
optionally at least one rheology modifier;
optionally at least one dispersing agent;
optionally at least one ingredient (I_{C}).

Another aspect of the present invention is a method for the manufacturing of the composition (C), as detailed above.

It is further understood that all definitions and preferences, as described above, equally apply for all further embodiments, as described below.

The composition (C) of the present invention can be prepared by a variety of methods known in the art. For manufacturing composition (C) of the present invention, several methods known in the art may adequately be used.

In one embodiment of the present invention, the method for the manufacturing of the composition (C), as detailed above, comprises intimate admixing of the at least one aqueous dispersion comprising the polymer (A), as detailed above, the redispersible polymer powder, as detailed above, and the at least one filler, as detailed above, optionally the at least one crosslinking agent, as detailed above, optionally the at least one surfactant, as detailed above, optionally the at least one plasticizer, as detailed above, optionally the at least one rheology modifier, as detailed above, optionally the at least one dispersing agent, as detailed above, and optionally the at least one additional ingredient (I_{C}), as detailed above.

In one specific embodiment of the present invention, the method for the manufacturing of the composition (C), as detailed above, comprises intimate admixing:
from 5.00 to 80.00 wt. % of at least one aqueous dispersion comprising at least one polymer [polymer (A), herein after] selected from the group consisting of acrylic polymer, polyurethane, polyvinyl ester, polysiloxane, copolymers, and a mixture of two or more thereof;
from 1.00 to 50.00 wt. % of at least one redispersible polymer powder;
from 5.00 to 70.00 wt. % of at least one filler;
optionally at least one crosslinking agent;
optionally at least one surfactant;
optionally at least one plasticizer;
optionally at least one rheology modifier;
optionally at least one dispersing agent;
optionally at least one ingredient (I_{C});
   wherein all wt. % are relative to the total weight of the composition (C).

A low shear mixing technique is preferred. One skilled in the art can make appropriate decisions and/or experimentally determine appropriate mixing conditions whereby the mixing is performed at low shear forces.

Typically said intimate admixing, as detailed above, may be carried out by a variety of conventional mixing techniques known to those skilled in the art. In particular, said intimate admixing can be carried out by using static mixers, ribbon blenders, V blenders, continuous processors, cone screw blenders, screw blenders, double cone blenders, double planetary mixers, dissolver mixers, high viscosity mixers, counter-rotating mixers, double and triple shaft mixers, vacuum mixers, dispersion mixers, paddle mixers, Z blade mixers, jet mixers, mobile mixers, drum blenders, intermix mixers, planetary mixers, high intensity mixers or dual asymmetric centrifugal mixers such as notably SpeedMixer™ type mixers, and the like so as to obtain a physical mixture.

It is understood that the skilled person in the art will carry out said intimate admixing according to general practice such as notably using optimal times, speeds, weights, volumes and batch quantities.

Furthermore, it is understood that any order of intimate admixing of the various components as comprised in the composition (C), as detailed above, is acceptable.

A further aspect of the present invention is a waterborne adhesive and/or waterborne sealant comprising the composition (C), as detailed above.

The waterborne sealant comprising the composition (C), as detailed above, is especially suitable as a construction sealant.

The water-based sealant comprising the composition (C), as detailed above, is especially suitable as a construction sealant according to DIN EN ISO 11600.

The inventors have surprisingly found that when the composition (C) is comprised in a waterborne adhesive and/or waterborne sealant, said waterborne adhesive and/or waterborne sealant yields a high solids content level, thereby leading to cured sealants and/or adhesives being characterized by a reduction of shrinkage, while having maintained or having improved other mechanical properties such as elastic recovery, elongation at break, high or low modulus, and adhesion, as demonstrated in the experiments below.

When applying the composition (C), as detailed above, the water as comprised within said composition (C) is at least partially evaporated so that said composition (C) physically cures and hardens and builds strength. Furthermore, for example when the polymer (A) as comprised within the composition (C) is a silane-modified polymer (A), as detailed above, the silane groups of the silane-modified polymer (A), upon evaporation of the water as comprised within said composition (C), become exposed to and come in contact with ambient moisture. The silane groups are characterized in that they hydrolyze upon contact with moisture. This leads to the formation of organosilanols and, by subsequent condensation reactions to organosiloxanes. As a result of these reactions, chemical curing of the composition takes place. This process is also referred to as crosslinking. The rate of the chemical curing process is determined by various factors, such as the rate of diffusion of water, the temperature, the ambient humidity and the bonding geometry, and generally slows down as chemical curing progresses.

The present invention further relates to a cured composition (C), obtainable from the composition (C), as described in the preceding.

The cured composition (C), obtainable from the composition (C), as detailed above, is advantageously characterized by an elastic recovery (resilience) at 60% elongation of higher than 60.0%, preferably higher than 62.0%, preferably higher than 66.0%, preferably higher than 68.0%, as measured in accordance with DIN EN ISO 7389:2002 (DIN concrete slabs, curing: 28 days at 23° C., and 50% relative humidity).

Furthermore, the cured composition (C), obtainable from the composition (C), as detailed above, is advantageously characterized by a loss of volume at 23° C. of less than 25.0%, preferably less than 23.0%, more preferably less than 21.0%, as measured in accordance with ISO 10563:2017.

Furthermore, the cured composition (C), obtainable from the composition (C), as detailed above, is advantageously characterized by a water absorption of higher than 5.0 wt. %, preferably higher than 6.0 wt. %, preferably higher than 7.0 wt. %, as measured in accordance with the experimental protocol as described below and in accordance with the experimental section.

The percentage (%) absorption of water in a cured composition (C), obtained by curing a composition (C), as detailed above, is determined via an internally developed test methodology. A polyethylene foil or film was first coated with the aqueous composition (C) until a 2 mm thick wet coating was obtained on said polyethylene foil or film. The coated composition (C) was then cured during 7 days at 23° C. until a cured composition (C) was obtained as a cured film. The cured film was first weighed at 23° C. Said cured film was then immersed in a water bath during 24 hours at 23° C. In a next step, after immersion, the cured film was wiped dry with tissue and was rested for 1 hour at 23° C. Thereafter, the cured film was weighed again at 23° C.

According to one embodiment of the cured composition (C) of the present invention, the cured composition (C), obtainable from the composition (C), as detailed above, is advantageously characterized by an elastic recovery (resilience) at 100% elongation of higher than 60%, preferably higher than 70%, as measured in accordance with DIN EN ISO 7389:2002 (DIN concrete slabs, curing: 28 days at 23° C., and 50% relative humidity).

According to the present invention, the composition (C), as detailed above, is preferably contained for storage in a container. The container is suitably in the form of a drum, a bag, a cartridge or respectively in the form of a sausage suitable for use in conjunction with application equipment.

Typically, the composition (C), as detailed above, is storage-stable, i.e. said composition (C) can be stored over a period of several months to a year and longer without changing to an extent relevant to its use with respect to its application properties or its properties after curing.

Preferably, the composition (C), as detailed above, is stored in one container as such (one-component system).

In a one-component system, the composition (C), as detailed above, may for instance be manufactured right before the introduction of said composition (C) in the container.

Alternatively, in a one-component system, the composition (C), as detailed above, may for instance be manufactured by adding the at least one aqueous dispersion comprising the polymer (A), as detailed above, the redispersible polymer powder, as detailed above, and the at least one filler, as detailed above, optionally the at least one crosslinking agent, as detailed above, optionally the at least one surfactant, as detailed above, optionally the at least one plasticizer, as detailed above, optionally the at least one rheology modifier, as detailed above, optionally the at least one dispersing agent, as detailed above, and optionally the at least one additional ingredient (I_{C}), as detailed above, to the container, thereby forming the composition (C) inside the container.

If desired, instead of storing the composition (C), as detailed above, in one container and thereby using a one-component system, a two-component system may be used wherein each of the components of the composition (C), are packed separately, either in separate containers or in separate chambers of a single container. In said two-component system, the mixing of the components is performed at the moment of application when the first component is mixed with the second component, thereby forming the composition (C). It is understood that the first component may comprise the at least one aqueous dispersion comprising the polymer (A), as detailed above, and the second component may comprise the redispersible polymer powder, as detailed above, and the at least one filler, as detailed above, or vice versa. Alternatively, for instance, when the polymer (A) as comprised within the at least one aqueous dispersion is a silane-modified acrylic polymer being a silyl-terminated acrylic polymer, as detailed above, the first component may comprise an alkenyl-terminated acrylic polymer, as detailed above, and the second component may comprise an appropriate silylating component, as detailed above, in order to give the silyl-terminated acrylic polymer as the polymer (A).

In the case of a two-component system, chemical curing may be achieved by the reaction of the first component with the second component. The curing reaction in this case usually proceeds faster.

It is also a further object of the present invention to provide uses of said waterborne sealant and/or waterborne adhesive having a high solids content.

Correspondingly diverse are the possibilities for use of the composition (C), as detailed above. For example, the compositions (C) can be used to produce elastomers, sealants, adhesives, elastic adhesive systems, rigid and flexible foams, any of a very wide variety of coating systems, or for impression compounds. These products can be applied in any form, as for example by spreading, spraying, pouring, pressing, knifing, etc.

According to the present invention, the composition (C), as detailed above, is, for example, used in a method of bonding two substrates or at least part of two substrates.

Thus, another aspect of the present invention is a method of bonding two substrates or at least part of two substrates by using the composition (C), as detailed above, wherein said method comprises the following steps: i) applying the composition (C), according to the description above, to at least part of a substrate S1 and/or or at least part of a substrate S2; ii) contacting at least part of substrates S1 and S2 via the applied composition (C); iii) curing the composition (C) thereby forming a cured composition (C); wherein substrates S1 and S2 may be the same or different from each other.

Furthermore, the composition (C) according to the present invention, may also be used in a method of sealing or coating.

Thus, another aspect of the present invention is a method of sealing or coating, by using the composition (C), as detailed above, wherein said method comprises the following steps:
i′) applying the composition (C), according to the description above, to at least part of a substrate S1 and/or between at least part of two substrates S1 and S2;
ii′) curing the composition (C) thereby forming a cured composition (C); wherein substrates S1 and S2 may be the same or different from each other.

In the case of a two-component system, step i) or i′) of the application of the composition (C) is preceded by a step of mixing the two components thereby forming the composition (C), as described above.

Suitable substrates S1 and/or S2 are, for example, substrates that may be selected from the group consisting of concrete, mortar, clinker, brick, ceramic, gypsum, natural stones such as granite or marble, glass, glass-ceramic, metal or metal alloys such as aluminum, steel, nonferrous metal, galvanized metal, wood, plastics such as PVC, polycarbonate, polymethyl(meth)acrylate, polyester, epoxy resin, paint and lacquer.

The articles, which are bonded, sealed or coated with the composition (C), as detailed above, may be for example, an industrially manufactured good or a consumer product, for example, a window or façade, solar panels, a household appliance such as sanitary appliances, or a means of transportation, for example, a vehicle, or an attachment part of a vehicle, boots, caravans, and the like.

The composition (C), as detailed above, may be applied to the substrate using a suitable device, for example, in the form of a bead having, for example, an essentially circular or triangular cross-sectional area. Suitable methods for applying the composition (C) as described above, include for example, the application from commercial cartridges, which may be operated manually, or by means of compressed air, or from a drum or bucket using a pump or an extruder, optionally by means of an application robot. The composition (C), as described above, with good application properties, has high stability and short stringing. This means, after application it remains in the applied form, i.e. does not spread out, and, upon removal of the application device, forms no or only a very short string, so that the substrate does not become dirty.

### Experimental Test Results

The invention will be now described in more details with reference to the following examples, whose purpose is merely illustrative and not intended to limit the scope of the invention.

### Test Methods

### Loss of Volume

The loss of volume in cured joints, obtained by curing of the various aqueous compositions as described in Table 2, is determined in accordance with ISO 10563:2017.

### Elastic Recovery

The elastic recovery (resilience) of cured joints, obtained by curing of the various aqueous compositions as described in Table 2, at 60% elongation, or at 100% elongation respectively, is determined in accordance with DIN EN ISO 7389:2002 (DIN concrete slabs, curing: 28 days at 23° C., and 50% relative humidity).

### Tensile Properties (Secant Modulus, and Fracture Type)

The tensile properties (secant modulus, and fracture type) of cured joints, obtained by curing of the various aqueous compositions as described in Table 2, are determined at 23° C. in accordance with DIN EN ISO 8339:2005.

### Water Absorption

The percentage (%) absorption of water in cured films, obtained by curing of the various aqueous compositions as described in Table 2, is determined via an internally developed test methodology. A polyethylene foil or film was first coated with the respective aqueous composition until a 2 mm thick wet coating was obtained on said polyethylene foil or film. The coated composition was then cured during 7 days at 23° C. until a cured film was obtained. The cured film was first weighed at 23° C. Said cured film was then immersed in a water bath during 24 hours at 23° C. In a next step, after immersion, the cured film was wiped dry with tissue and was rested for 1 hour at 23° C. Thereafter, the cured film was weighed again at 23° C.

### Solids Content

The total solids content of the various aqueous compositions, and as expressed relative to the total weight of said compositions respectively, is determined in accordance with the standard DIN EN ISO 3251:2019.

### General Procedure for Manufacturing a Composition (C) According to the Invention and the Comparative Examples 1 and 8.

### Examples 2-7 (Ex2 to Ex7) and Example 9 (Ex9)

Examples 2-7 (Ex2 to Ex7) and Example 9 (Ex9) were prepared by admixing and homogenizing together the various ingredients as described in Tables 2-3 (i.e. nature and amounts), respectively. The admixing of the various ingredients was carried out by using an Hauschild Speedmixer™ (DAC 150.1FVZ) at 2600 rpm for 30 seconds thereby obtaining composition (C), according to the invention.

All contents in Tables 2-3 are given in wt. %, relative to the total weight of the respective compositions, unless stated otherwise.

### Comparative Example 1 (CEx1)

Comparative Example 1 (CEx1) of Table 2 was prepared according to the same procedure as for Examples 2-7 (Ex2 to Ex7), as described above, except that no redispersible polymer powder was used. Moreover, the amount of the redispersible polymer powder in Examples 2-7 (Ex2 to Ex7) was entirely replaced by plasticizer (Hexamoll® DINCH) on the one hand and filler (Omyacarb® 2GU) on the other hand.

### Comparative Example 8 (CEx8)

Comparative Example 8 (CEx8) of Table 3 was prepared according to the same procedure as for Example 9 (Ex9), as described above, except that no filler was used.

TABLE 1
LIST OF PRODUCTS AND DESCRIPTION

| Aqueous dispersion | | |
|---|---|---|
| comprising the | | |
| polymer (A) | | |
| according to the | | |
| invention | Company | Description |
| Acronal ® V 278 | BASF AG, | aqueous dispersion of acrylic polymer |
| | Germany | (65 wt. % solids content) |
| Acronal ® DS5036 X | BASF AG, | aqueous dispersion of silane-modified |
| SIL | Germany | acrylic polymer (60 wt. % solids content) |

| | Company | Functionality |
|---|---|---|
| Redispersible | | |
| polymer powder | | |
| according to | | |
| the invention | | |
| VINNAPAS ® 5048 H | Wacker | copolymer of vinyl acetate and ethylene |
| | Chemie AG | |
| VINNAPAS ® 7055 E | Wacker | copolymer (terpolymer) of vinyl acetate, |
| | Chemie AG | ethylene and vinyl ester. |
| VINNAPAS ® 8034 H | Wacker | copolymer (terpolymer) of vinyl chloride, |
| | Chemie AG | ethylene and vinyl laurate |
| Acronal ® P 5466 X | BASF AG, | copolymer of acrylic acid ester and |
| | Germany | styrene |
| Acronal ® S 430 P | BASF AG, | copolymer of acrylic acid ester and |
| | Germany | styrene |
| Crosslinking agent | | |
| Zinc Oxide Solution | BASF AG, | zinc ammonium carbonate solution |
| No. 1 | Germany | (15 wt. % non-volatiles) |
| Surfactant | | |
| Disponil ® SDS 15 | BASF AG, | aqueous dispersion of sodium lauryl |
| | Germany | sulphate |
| | | (15 wt. % active anionic surfactant) |
| Plasticizer | | |
| Hexamoll ® DINCH | BASF AG, | non-phthalate plasticizer |
| | Germany | |
| Sovermol ® 1055 | BASF AG, | fatty acid polyester with epoxy groups |
| | Germany | |
| Rheology modifier | | |
| RHEOVIS ® AS1130 | BASF AG, | anionic polyacrylate copolymer (ASE) |
| | Germany | emulsion in water (30 wt. % solids |
| | | content) |
| Filler | | |
| Omyacarb ® 2GU | Omya | calcium carbonate based filler (D₅₀ ≤ 2.0 |
| | | μm) |
| Dispersing agent | | |
| Dispex ® N40 | BASF AG, | solution of a sodium salt of an acrylic |
| | Germany | copolymer in water (45 wt. % solids |
| | | content) |
| Dispex ® CX 4231 | BASF AG, | ammonium salt of a carboxylic acid |
| | Germany | copolymer in water (30 wt. % solids |
| | | content) |
| Ingredient (I_{C}) | | |
| Tronox CR-828 | Tronox | titanium dioxide pigment |
| Acticide ® MV | Thor | biocide solution based on a mixture of 5- |
| | | chloro-2-methyl-4-isothiazolin-3-one |
| | | and 2-methyl-4-isothiazolin-3-one |
| BIT-10 biocide | Lanxess | benzisothiazolinone solution (10 wt. %) |

TABLE 2
COMPOSITIONS (C): COMPARATIVE EXAMPLE 1 (CEx1) AND EXAMPLES 2-7 (EX2 TO
EX7) - WATER ABSORPTION IN FILMS AND MECHANICAL PROPERTIES IN JOINTS

| Example number | CEx1 | Ex2 | Ex3 | Ex4 | Ex5 | Ex6 | Ex7 |
|---|---|---|---|---|---|---|---|
| Polymer (A) according to the invention | Amount (in wt. %) | | | | | | |
| (aqueous dispersion) | | | | | | | |
| Acronal ® V 278 (65 wt. % solids content) | 29.9 | 30.4 | 30.4 | 30.4 | 30.4 | 30.4 | 0.0 |
| Acronal ® DS5036 X SIL (60 wt. % solids content) | 0.0 | 0.0 | 0.0 | 0.0 | 0.0 | 0.0 | 30.4 |
| Redispersible polymer powder according to | Amount (in wt. %) | | | | | | |
| the invention | | | | | | | |
| VINNAPAS ® 7055 E | 0.0 | 5.1 | 0.0 | 0.0 | 0.0 | 0.0 | 0.0 |
| VINNAPAS ® 8034 H | 0.0 | 0.0 | 5.1 | 0.0 | 0.0 | 0.0 | 5.1 |
| VINNAPAS ® 5048 H | 0.0 | 0.0 | 0.0 | 5.1 | 0.0 | 0.0 | 0.0 |
| Acronal ® P 5466 X | 0.0 | 0.0 | 0.0 | 0.0 | 5.1 | 0.0 | 0.0 |
| Acronal ® S 430 P | 0.0 | 0.0 | 0.0 | 0.0 | 0.0 | 5.1 | 0.0 |
| Crosslinking agent | Amount (in wt. %) | | | | | | |
| Zinc Oxide Solution No. 1 | 0.1 | 0.1 | 0.1 | 0.1 | 0.1 | 0.1 | 0.1 |
| Surfactant | Amount (in wt. %) | | | | | | |
| Disponil ® SDS 15 | 0.2 | 0.2 | 0.2 | 0.2 | 0.2 | 0.2 | 0.2 |
| Plasticizer | Amount (in wt. %) | | | | | | |
| Hexamoll ® DINCH | 10.0 | 9.1 | 9.1 | 9.1 | 9.1 | 9.1 | 9.1 |
| Rheology modifier | Amount (in wt. %) | | | | | | |
| RHEOVIS ® AS1130 | 0.1 | 0.1 | 0.1 | 0.1 | 0.1 | 0.1 | 0.1 |
| Filler | Amount (in wt. %) | | | | | | |
| Omyacarb ® 2GU | 57.5 | 52.7 | 52.7 | 52.7 | 52.7 | 52.7 | 52.7 |
| Dispersing agent | Amount (in wt. %) | | | | | | |
| Dispex ® N40 | 1.0 | 1.0 | 1.0 | 1.0 | 1.0 | 1.0 | 1.0 |
| Ingredient (I_{C}) | Amount (in wt. %) | | | | | | |
| titanium dioxide Tronox CR-828 | 1.0 | 1.0 | 1.0 | 1.0 | 1.0 | 1.0 | 1.0 |
| Acticide ® MV | 0.1 | 0.1 | 0.1 | 0.1 | 0.1 | 0.1 | 0.1 |
| BIT-10 biocide | 0.2 | 0.2 | 0.2 | 0.2 | 0.2 | 0.2 | 0.2 |
| Water absorption (wt. %) in films | 3.1 | 6.3 | 6.1 | 5.3 | 7.8 | 7.2 | 6.9 |
| | Mechanical properties in joints | | | | | | |
| Loss of volume (%) | 21.8 | 19.4 | 19.5 | 19.7 | 19.4 | 19.5 | 20.1 |
| Elastic recovery at 60% elongation (%) | 55.8 | 68.8 | 63.4 | 62.1 | 68.7 | 66.8 | 68.8 |
| Elastic recovery at 100% elongation (%) | 64.8 | 67.2 | 64.3 | 67.4 | 68.3 | 63.7 | 67.2 |
| Secant modulus (N/mm²; MPa) | 0.084 | 0.117 | 0.123 | 0.125 | 0.115 | 0.115 | 0.135 |
| Solids content (wt. %) | 88.44 | 88.39 | 88.29 | 88.41 | 88.37 | 88.32 | 86.75 |
| Fracture type | cohesive | cohesive | cohesive | cohesive | cohesive | cohesive | cohesive |

The results as described in Table 2 now clearly demonstrate that as a consequence of the presence of a redispersible polymer powder in the aqueous compositions of Ex2 to Ex7, suitable for use as a waterborne sealant and/or a waterborne adhesive, said aqueous compositions of Ex2 to Ex7 are being characterized by having a high solids content level, thereby further demonstrating, in the cured state, a reduction of shrinkage as measured by means of the loss of volume and the absorption of water. Further, the aqueous compositions of Ex2 to Ex7, in the cured state, are simultaneously characterized by having good to even improved mechanical properties as measured in terms of the elastic recovery at 60% elongation, secant modulus, and fracture type.

TABLE 3
COMPOSITIONS (C): COMPARATIVE EXAMPLE 8 (CEx8) AND
EXAMPLE 9 (Ex9) - MECHANICAL PROPERTIES IN JOINTS

| Example number | CEx8 | Ex9 |
|---|---|---|
| Polymer (A) according to the invention | Amount (in wt. %) | |
| (aqueous dispersion) | | |
| Acronal ® DS5036 X SIL | 56.8 | 32.5 |
| (60 wt. % solids content) | | |
| Redispersible polymer powder | Amount (in wt. %) | |
| according to the invention | | |
| VINNAPAS ® 7055 E | 18.7 | 10.7 |
| Crosslinking agent | Amount (in wt. %) | |
| Zinc Oxide Solution No. 1 | 0.2 | 0.1 |
| Surfactant | Amount (in wt. %) | |
| Disponil ® SDS 15 | 0.4 | 0.2 |
| Plasticizer | Amount (in wt. %) | |
| Hexamoll ® DINCH | 17.0 | 9.7 |
| Sovermol ® 1055 | 1.9 | 1.1 |
| Rheology modifier | Amount (in wt. %) | |
| RHEOVIS ® AS1130 | 0.2 | 0.1 |
| Filler | Amount (in wt. %) | |
| Omyacarb ® 2GU | 0.0 | 42.8 |
| Dispersing agent | Amount (in wt. %) | |
| Dispex ® CX 4231 | 1.9 | 1.7 |
| Ingredient (I_{C}) | Amount (in wt. %) | |
| titanium dioxide Tronox CR-828 | 3.0 | 1.6 |
| | Mechanical properties in joints | |
| Elastic recovery at 60% elongation (%) | 46.77 | 65.28 |
| Elastic recovery at 100% elongation (%) | 60.92 | 68.13 |

The results as described in Table 3 clearly demonstrate that as a consequence of the absence of a filler in the aqueous composition of CEx8, said aqueous composition CEx8, which appears as a very sticky composition, is characterized by greatly reduced mechanical properties in joints as measured in terms of the elastic recovery in the cured state. On the contrary, good mechanical properties in joints as measured in terms of the elastic recovery in the cured state are obtained for the aqueous composition of Ex9, suitable for use as a waterborne sealant and/or a waterborne adhesive, in the presence of a filler.

1. An aqueous composition [composition (C), herein after] suitable for use as a waterborne sealant and/or a waterborne adhesive comprising, relative to the total weight of the composition (C):
from 5.00 to 80.00 percent by weight [wt. %, herein after] of at least one aqueous dispersion comprising at least one polymer [polymer (A), herein after] selected from the group consisting of acrylic polymer, polyurethane, polyvinyl ester, polysiloxane, copolymers, and a mixture of two or more thereof;
from 1.00 to 50.00 wt. % of at least one redispersible polymer powder; and
from 5.00 to 70.00 wt. % of at least one filler.

2. The composition (C) according to claim 1, wherein the weight percent of the at least one aqueous dispersion, relative to the total weight of the composition (C), ranges from 10.00 to 70.00 wt. %, preferably from 15.00 to 60.00 wt. %, more preferably from 20.00 to 55.00 wt. %, even more preferably from 20.00 to 45.00 wt. %, most preferably from 25.00 to 35.00 wt. %.

3. The composition (C) according to claim 1, wherein the polymer (A) is an acrylic polymer, whereby the acrylic polymer comprises recurring units derived from at least one (meth)acrylic acid monomer or/and at least one (meth)acrylic acid ester monomer.

4. The composition (C) according to claim 1, wherein the at least one redispersible polymer powder is a (co)polymer derived from at least one ethylenically unsaturated monomer selected from the group consisting of vinyl aromatic monomers, vinyl halide monomers, vinyl ester monomers of branched or unbranched alkylcarboxylic acids having from 1 to 15 carbon atoms, (meth)acrylic ester monomers of branched or unbranched alcohols having from 1 to 10 carbon atoms, olefin monomers, and diene monomers.

5. The composition (C) according to claim 1, wherein the at least one redispersible polymer powder is selected from the group consisting of vinyl acetate polymers; vinyl acetate-ethylene copolymers having an ethylene content of from 1.0 to 60.0 wt. %; vinyl acetate copolymers with from 1.0 to 50.0 wt. % of one or more further vinyl ester monomers such as vinyl laurate, vinyl pivalate, and vinyl versatates, with these copolymers being able to contain from 1.0 to 40.0 wt. % of ethylene as further monomer; vinyl acetate-acrylic ester copolymers which contain from 1.0 to 60.0 wt. % of acrylic ester, preferably n-butyl acrylate, and which may contain from 1.0 to 40.0 wt. % of ethylene; vinyl ester-ethylene-vinyl chloride copolymers; vinyl chloride-ethylene copolymers; styrene-butadiene copolymers; and styrene-acrylic ester copolymers such as styrene-n-butyl acrylate or styrene-2-ethylhexylacrylate having a styrene content of in each case from 10.0 to 70.0 wt. %.

6. The composition (C) according to claim 1, wherein the at least one redispersible polymer powder is selected from the group consisting of vinyl acetate polymer; vinyl acetate-ethylene copolymer; vinyl acetate-vinyl ester copolymer and vinyl acetate-vinyl ester-ethylene copolymer, with the vinyl ester monomers being selected in each case from the group consisting of vinyl laurate, vinyl pivalate and vinyl versatates; vinyl acetate-acrylic ester copolymer; vinyl acetate-acrylic ester-ethylene copolymer; styrene-butadiene copolymer; and styrene-acrylic ester copolymer, with the acrylic esters in each case being esters of branched or unbranched alcohols having from 1 to 10 carbon atoms.

7. The composition (C) according to claim 1, wherein the weight percent of the at least one redispersible polymer powder, relative to the total weight of the composition (C), ranges from 2.00 to 40.00 wt. %, preferably from 2.50 to 35.00 wt. %, more preferably from 3.00 to 30.00 wt. %, even more preferably from 3.50 to 25.00 wt. %, yet even more preferably from 4.00 to 20.00 wt. %, most preferably from 4.50 to 15.00 wt. %.

8. The composition (C) according to claim 1, wherein the at least one filler, relative to the total weight of the composition (C), is present in an amount from 10.00 to 67.00 wt. %, preferably from 15.00 to 65.00 wt. %, preferably from 20.00 to 63.00 wt. %, preferably from 25.00 to 60.00 wt. %, preferably from 30.00 to 57.00 wt. %, more preferably from 35.00 to 55.00 wt. %.

9. The composition (C) according to claim 1, wherein the at least one filler is selected from the group consisting of natural, grounded or precipitated calcium carbonates which are optionally coated with fatty acids, or fatty acid esters; talc; silica such as fumed silica, precipitated silica, crystalline silica, molten silica, fused silica, silicic anhydride, aqueous silicic acid, and amorphous spherical silica; carbon black; dolomites; clay; calcined clay; kaolin; calcined kaolin; montmorillomte; wollastonite; titanium oxide; aluminum oxide; aluminum hydroxide; magnesium hydroxide; gypsum; balloon; solid beads such as solid glass spheres; and hollow beads.

10. The composition (C) according to claim 1, wherein the at least one filler is selected from the group consisting of natural, grounded or precipitated calcium carbonates which are optionally coated with fatty acids, or fatty acid esters; talc; silica such as fumed silica, precipitated silica, crystalline silica, molten silica, fused silica, silicic anhydride, aqueous silicic acid, and amorphous spherical silica; carbon black; dolomites; clay; calcined clay; and titanium oxide.

11. The composition (C) according to claim 1, wherein the composition (C) comprises at least one crosslinking agent selected from the group consisting of zinc oxide, oxazolines, polyisocyanates, aziridines, and silanes.

12. The composition (C) according to claim 1, wherein the composition (C) comprises at least one surfactant selected from the group consisting of anionic, cationic, zwitterionic or non-ionic surfactants.

13. A method for the manufacturing of the composition (C), according to claim 1, wherein the method comprises the steps of intimate admixing:
from 5.00 to 80.00 wt. % of at least one aqueous dispersion comprising at least one polymer [polymer (A), herein after] selected from the group consisting of acrylic polymer, polyurethane, polyvinyl ester, polysiloxane, copolymers, and a mixture of two or more thereof;
from 1.00 to 50.00 wt. % of at least one redispersible polymer powder;
from 5.00 to 70.00 wt. % of at least one filler;
optionally at least one crosslinking agent;
optionally at least one surfactant;
optionally at least one plasticizer;
optionally at least one rheology modifier;
optionally at least one dispersing agent;
optionally at least one ingredient (IC);
wherein all wt. % are relative to the total weight of the composition (C).

14. A waterborne adhesive and/or waterborne sealant comprising the composition (C), according to claim 1.

15. A cured composition (C), obtainable from the composition (C) according to claim 1, wherein the cured composition (C) is characterized by a loss of volume of less than 25.0%, preferably less than 23.0%, more preferably less than 21.0%, as measured in accordance with ISO 10563:2017.

16. The cured composition (C) according to claim 15, wherein the cured composition (C) is characterized by an elastic recovery at 60% elongation of higher than 60.0%, preferably higher than 62.0%, preferably higher than 66.0%, preferably higher than 68.0%, as measured in accordance with DIN EN ISO 7389:2002.

17. A method of bonding two substrates or at least part of two substrates by using the composition (C), according to claim 1, wherein said method comprises the following steps:
i. applying the composition (C) to at least part of a substrate S1 and/or or at least part of a substrate S2;
ii. contacting at least part of substrates S1 and S2 via the applied composition (C);
iii. curing the composition (C) thereby forming the cured composition (C);
wherein substrates S1 and S2 may be the same or different from each other.

18. A method of sealing or coating, by using the composition (C), according to claim 1, wherein said method comprises the following steps:
i′. applying the composition (C) to at least part of a substrate S1 and/or between at least part of two substrates S1 and S2;
ii′. curing the composition (C) thereby forming the cured composition (C);
wherein substrates S1 and S2 may be the same or different from each other.
